(19) United States
(12) Patent Application Publication
(10) Pub. No.: US 2026/0093509 A1
(43) Pub. Date: Apr. 2, 2026

(54) ELECTRONIC DEVICE FOR SHARING ACCESSIBILITY SETTINGS AND METHOD THEREOF

(71) Applicant: Samsung Electronics Co., Ltd., Suwon-si (KR)

(72) Inventors: Miyoung LEE, Suwon-si (KR); Seyeon LEE, Suwon-si (KR); Jungkun LEE, Suwon-si (KR); Jiyu LEE, Suwon-si (KR); Youngkyung JUNG, Suwon-si (KR); Myoha KIM, Suwon-si (KR); Sunah KIM, Suwon-si (KR)

(21) Appl. No.: 19/222,682

(22) Filed: May 29, 2025

Related U.S. Application Data
(63) Continuation of application No. PCT/KR2025/007071, filed on May 26, 2025.

(30) Foreign Application Priority Data
Sep. 30, 2024 (KR) 10-2024-0133195
Dec. 3, 2024 (KR) 10-2024-0177656
Dec. 12, 2024 (KR) 10-2024-0184986

(51) Int. Cl. G06F 9/451; G06F 21/31

(52) U.S. Cl. CPC G06F 9/453; G06F 21/31

(57) ABSTRACT

An electronic device may include communication circuitry, a processor(s), and memory configured to store instructions. The instructions, when executed by the processor(s), may cause the electronic device to: log in to a server with a user account; while the electronic device is logged in with the user account, receive, through the communication circuitry, an accessibility feature list indicating at least one accessibility feature in use on a first electronic device, wherein the first electronic device is logged in to the server with the user account; identify at least one accessibility feature usable by the electronic device from the accessibility feature list; identify, from the at least one accessibility feature usable by the electronic device, a first accessibility feature that is not being used by the electronic device; and apply the first accessibility feature to the electronic device.

### CROSS-REFERENCE TO RELATED APPLICATIONS

This application is a continuation application of International Application No. PCT/KR2025/007071 designating the United States, filed on May 26, 2025, in the Korean Intellectual Property Receiving Office and claiming priority to Korean Patent Application No. 10-2024-0133195 filed on Sep. 30, 2024, Korean Patent Application 10-2024-0177656 filed on Dec. 3, 2024, and Korean Patent Application 10-2024-0184986 filed on Dec. 12, 2024, the disclosures of which are all hereby incorporated by reference herein in their entireties.

### TECHNICAL FIELD

Certain example embodiments may relate to an electronic device for sharing accessibility settings and/or a method therefor.

### BACKGROUND ART

There have been gradual increases in various services and additional functions provided through user terminals, for example, electronic devices such smartphones. In order to increase the usability of such electronic devices and to satisfy various user demands, communication service providers or electronic device manufacturers are completing to develop electronic devices that provide various functions. Accordingly, the level of sophistication of various functions provided through electronic device is increasing.

In line with development of wireless communication technologies, devices that use artificial intelligence (AI) have been introduced widely. For example, home appliances to which the Internet-of-things (IoT) technology is applied and is connected to networks may use the AI. The IoT technology may collect and analyze data generated by devices and may provide intelligent Internet technology services which create new values to human life. Through merge and combination between existing Internet technologies and various industries, the IoT technology may be applied to various fields, such as smart homes, smart buildings, smart cities, smart cars, and smart home appliances.

Various home appliances are provided for the convenience of users at home. Various services have been proposed to facilitate the manipulation or control of home appliances by using the IoT technology. Home network technologies may provide various services to uses at home through home networks. For example, a user may control various controlled devices (for example, home appliances to which the IoT technology is applied) constituting a home network by using his/her personal electronic device (for example, smartphone). The user may want to be provided with more diversified services to control the controlled devices. Accordingly, there is a need to develop various technologies for managing the controlled devices by reflecting the user's intent.

The above-described information may be provided as related art for the purpose of assisting in understanding the disclosure. No assertion or decision is made as to whether any of the above might be applicable as prior art with regard to the disclosure.

### SUMMARY

Certain example embodiments may provide an electronic device for sharing accessibility settings and a method therefor.

Certain example embodiments may provide an electronic device and a method wherein the electronic device's accessibility feature list and user account information are transmitted to a peripheral device such that the peripheral device applies the electronic device's accessibility settings.

A second electronic device according to an example embodiment of the disclosure may include communication circuitry, at least one processor comprising processing circuitry, and memory storing instructions. The instructions, when executed by the at least one processor individually or collectively, may cause the second electronic device to: log in to a server with a user account through the communication circuitry. The instructions, when executed by the at least one processor individually or collectively, may cause the second electronic device to: while the second electronic device is logged in with the user account, receive, through the communication circuitry, an accessibility feature list indicating at least one accessibility feature in use on a first electronic device, wherein the first electronic device is logged in to the server with the user account. The instructions, when executed by the at least one processor individually or collectively, may cause the second electronic device to: identify at least one accessibility feature usable by the second electronic device from the accessibility feature list. The instructions, when executed by the at least one processor individually or collectively, may cause the second electronic device to: identify, from the identified at least one accessibility feature usable by the second electronic device, a first accessibility feature that is not being used by the second electronic device. The instructions, when executed by the at least one processor individually or collectively, may cause the second electronic device to: apply the first accessibility feature to the second electronic device.

A server according to an example embodiment may include communication circuitry, at least one processor comprising processing circuitry, and memory storing instructions. The instructions, when executed by the at least one processor individually or collectively, may cause the server to: identify that a first electronic device is logged in with a user account. The instructions, when executed by the at least one processor individually or collectively, may cause the server to: identify that a second electronic device is logged in with the user account. The instructions, when executed by the at least one processor individually or collectively, may cause the server to: while the first electronic device and the second electronic device are logged in with the user account, receive, through the communication circuitry, a first accessibility feature list indicating at least one accessibility feature in use on the first electronic device. The instructions, when executed by the at least one processor individually or collectively, may cause the server to: while the first electronic device and the second electronic device are logged in with the user account, receive, through the communication circuitry, a second accessibility feature list indicating at least one accessibility feature in use on the second electronic device. The instructions, when executed by the at least one processor individually or collectively, may cause the server to: identify at least one accessibility feature usable by the second electronic device from the first accessibility feature list. The instructions, when executed by the at least one processor individually or collectively, may cause the server to: identify, from the identified at least one accessibility feature, a first accessibility feature that is not being used by the second electronic device, based on the second accessibility feature list. The instructions, when executed by the at least one processor individually or collectively, may cause the server to: transmit an accessibility settings indication to the second electronic device through the communication circuitry so as to indicate that the identified first accessibility feature is to be applied.

A first electronic device according to an example embodiment may include communication circuitry, at least one processor comprising processing circuitry, and memory storing instructions. The instructions, when executed by the at least one processor individually or collectively, may cause the first electronic device to: while the first electronic device is logged in to a server with a user account, based on execution of an application, identify that a second electronic device is logged in with the user account. The instructions, when executed by the at least one processor individually or collectively, may cause the first electronic device to: based on identifying that the second electronic device is logged in with the user account, transmit an accessibility feature list indicating at least one accessibility feature in use on the first electronic device to the server or the second electronic device through the communication circuitry. The instructions, when executed by the at least one processor individually or collectively, may cause the first electronic device to: after transmitting the accessibility feature list, receive accessibility settings sharing information indicating a first accessibility feature among the at least one accessibility feature from the server or the second electronic device through the communication circuitry. The instructions, when executed by the at least one processor individually or collectively, may cause the first electronic device to: after displaying a user interface including the accessibility settings sharing information, receive a user input accepting to apply the first accessibility feature to the second electronic device through the user interface. The instructions, when executed by the at least one processor individually or collectively, may cause the first electronic device to: based on receiving the user input, transmit information accepting to apply the first accessibility feature to the second electronic device to the second electronic device directly or through the server.

A method by a second electronic device according to an example embodiment may include: logging in to a server with a user account; while the second electronic device is logged in with the user account, acquiring an accessibility feature list indicating at least one accessibility feature in use on a first electronic device, wherein the first electronic device is logged in to the server with the user account; identifying at least one accessibility feature usable by the second electronic device from the accessibility feature list; identifying, from the at least one accessibility feature usable by the second electronic device, a first accessibility feature that is not being used by the second electronic device; and applying the first accessibility feature to the second electronic device.

A method by a server according to an example embodiment may include: identifying that a first electronic device is logged in with a user account; identifying that a second electronic device is logged in with the user account; while the first electronic device and the second electronic device are logged in with the user account, receiving a first accessibility feature list indicating at least one accessibility feature in use on the first electronic device; while the first electronic device and the second electronic device are logged in with the user account, receiving a second accessibility feature list indicating at least one accessibility feature in use on the second electronic device; identifying at least one accessibility feature usable by the second electronic device from the first accessibility feature list; identifying, from the identified at least one accessibility feature, a first accessibility feature that is not being used by the second electronic device, based on the second accessibility feature list; and transmitting an accessibility settings indication to the second electronic device so as to indicate that the identified first accessibility feature is to be applied.

A non-transitory computer-readable storage medium according to an example embodiment may store one or more programs. The one or more programs may include instructions which, when executed by at least one processor individually or collectively, may cause a second electronic device to: log in to a server with a user account; while the second electronic device is logged in with the user account, receive, through the communication circuitry, an accessibility feature list indicating at least one accessibility feature in use on a first electronic device, wherein the first electronic device is logged in to the server with the user account; identify at least one accessibility feature usable by the second electronic device from the accessibility feature list; identify, from the at least one accessibility feature usable by the second electronic device, a first accessibility feature that is not being used by the second electronic device; and apply the first accessibility feature to the second electronic device.

A non-transitory computer-readable storage medium according to an example embodiment may store one or more programs. The one or more programs may include instructions which, when executed by at least one processor individually or collectively, may cause a server to: identify that a first electronic device is logged in with a user account; identify that a second electronic device is logged in with the user account; while the first electronic device and the second electronic device are logged in with the user account, receive a first accessibility feature list indicating at least one accessibility feature in use on the first electronic device; while the first electronic device and the second electronic device are logged in with the user account, receive a second accessibility feature list indicating at least one accessibility feature in use on the second electronic device; identify at least one accessibility feature usable by the second electronic device from the first accessibility feature list; identify, from the identified at least one accessibility feature, a first accessibility feature that is not being used by the second electronic device, based on the second accessibility feature list; and transmit an accessibility settings indication to the second electronic device so as to indicate that the identified first accessibility feature is to be applied.

A non-transitory computer-readable storage medium according to an example embodiment may store one or more programs. The one or more programs may include instructions which, when executed by at least one processor individually or collectively, may cause a first electronic device to: while the first electronic device is logged in to a server with a user account, based on execution of an application, identify that a second electronic device is logged in with the user account; based on identifying that the second electronic device is logged in with the user account, transmit an accessibility feature list indicating at least one accessibility feature in use on the first electronic device to the server or the second electronic device; after transmitting the accessibility feature list, receive accessibility settings sharing information indicating a first accessibility feature among the at least one accessibility feature from the server or the second electronic device; after displaying a user interface including the accessibility settings sharing information, receive a user input accepting to apply the first accessibility feature to the second electronic device through the user interface; and based on receiving the user input, transmit information accepting to apply the first accessibility feature to the second electronic device to the second electronic device directly or through the server.

The technical subjects pursued in the disclosure may not be limited to the above-mentioned technical subjects, and other technical subjects which are not mentioned may be clearly understood from the following descriptions by those skilled in the art to which the disclosure pertains.

### BRIEF DESCRIPTION OF DRAWINGS

With regard to the description of the drawings, the same or like reference signs may be used to designate the same or like elements.

FIG. 1 illustrates an Internet-of-things (IoT) system according to various example embodiments.

FIG. 2 is a block diagram of an electronic device in a network environment according to various example embodiments.

FIG. 3 illustrates a network including controlled devices according to an example embodiment.

FIG. 4A is a block diagram illustrating the configuration of a second electronic device according to an example embodiment.

FIG. 4B is a block diagram illustrating the configuration of a server configured to perform IoT control according to an example embodiment.

FIG. 5 illustrates an IoT client application's execution screen according to an embodiment.

FIG. 6 illustrates a configuration for processing accessibility settings sharing according to an example embodiment.

FIG. 7A illustrates a procedure of performing accessibility settings sharing by an IoT device according to an example embodiment.

FIG. 7B illustrates a procedure of performing accessibility settings sharing by a server according to an example embodiment.

FIG. 7C illustrates the matching relationship between accessibility features according to an example embodiment.

FIG. 8 is a flowchart illustrating a procedure of performing accessibility settings sharing by an IoT device according to an example embodiment.

FIG. 9 is a flowchart illustrating a procedure of performing accessibility settings sharing by a server according to an example embodiment.

FIG. 10 is a flowchart illustrating a procedure of analyzing accessibility settings according to an example embodiment.

FIG. 11 illustrates a procedure of permitting accessibility settings sharing according to an example embodiment.

FIG. 12A, FIG. 12B, FIG. 12C, and FIG. 12D illustrate accessibility feature matching according to an example embodiment.

FIG. 13 illustrates a procedure of performing accessibility settings sharing during onboarding according to an example embodiment.

FIG. 14 illustrates an accessibility settings sharing user interface according to an example embodiment.

FIG. 15 illustrates a procedure of performing accessibility settings sharing based on a user action according to an example embodiment.

FIG. 16 illustrates a procedure of setting accessibility settings sharing during device registration according to an example embodiment.

FIG. 17 is a flowchart illustrating a procedure of performing accessibility settings sharing by an IoT device during device registration according to an example embodiment.

FIG. 18 illustrates a procedure of setting accessibility settings sharing through account switching according to an example embodiment.

FIG. 19 is a flowchart illustrating a procedure of performing accessibility settings sharing by an IoT device during a user interaction according to an example embodiment.

FIG. 20A illustrates accessibility settings sharing based on a voice command according to an example embodiment.

FIG. 20B illustrates accessibility settings sharing based on a short-range communication scheme according to an example embodiment.

FIG. 21 is a flowchart illustrating a procedure of performing accessibility settings sharing by a voice command according to an example embodiment.

### DETAILED DESCRIPTION

Hereinafter, example embodiments of the disclosure will be described in detail with reference to the accompanying drawings. In describing the disclosure, a detailed description of known functions or configurations incorporated herein will be omitted when it is determined that the description may make the subject matter of the disclosure unnecessarily unclear. The terms which will be described below are terms defined in consideration of the functions in an example embodiment, and may be different according to users, intentions of the users, or customs. Therefore, the definitions of the terms should be made based on the contents throughout the specification.

It should be noted that the technical terms used herein are only used to describe specific embodiments, and are not intended to limit the disclosure. Alternatively, the technical terms used herein should be interpreted to have the same meaning as those commonly understood by a person skilled in the art to which the disclosure pertains, and should not be interpreted have excessively comprehensive or excessively restricted meanings unless particularly defined as other meanings. Alternatively, the technical terms used herein may be replaced with and understood as other technical terms that can be understood by those skilled in the art. The general terms used herein should be interpreted as defined in dictionaries or interpreted in the context of the relevant part, and should not be interpreted to have excessively restricted meanings.

A singular expression used herein may include a plural expression unless they are definitely different in the context. As used herein, such an expression as “comprises” or “include” should not be interpreted to necessarily include all elements or all steps described in the specification, and should be interpreted to be allowed to exclude some of them or further include additional elements or steps.

As used herein, the terms including an ordinal number, such as expressions “a first” and “a second”, may be used to described various elements, but the corresponding elements should not be limited by such terms. The above terms are used merely for the purpose of distinguishing one element from other elements. For example, a first element may be termed a second element, and similarly, a second element may be termed a first element without departing from the scope of protection of the disclosure.

It should be understood that when an element is referred to as being “connected” or “coupled” to another element, it may be connected or coupled directly to the other element, or any other element may be interposer between them. Contrarily, in the case where an element is referred to as being “directly connected” or “directly coupled” to any other element, it should be understood that no other element exists therebetween.

Hereinafter, embodiments according to the disclosure will be described in detail with reference to the accompanying drawings, and the same or similar elements are given the same and similar reference numerals, regardless of drawing signs, so duplicate descriptions thereof will be omitted. In describing example embodiments of the disclosure, descriptions related to technical contents well-known in the art and not associated directly with the disclosure will be omitted. It should be noted that the accompanying drawings are presented merely to help easy understanding of the disclosure, and are not intended to limit the disclosure. The disclosure should be construed to cover all changes, equivalents, and alternatives, in addition to the drawings.

In certain example embodiments, an electronic device will be described by way of example, but the electronic device may also be referred to as a terminal, a mobile station, a mobile equipment (ME), a user equipment (UE), a user terminal (UT), a subscriber station (SS), a wireless device, a handheld device, or an access terminal (AT). In certain example embodiments, the electronic device may be a device having a communication function, such as a mobile phone, a personal digital assistant (PDA), a smartphone, a wireless modem, or a notebook.

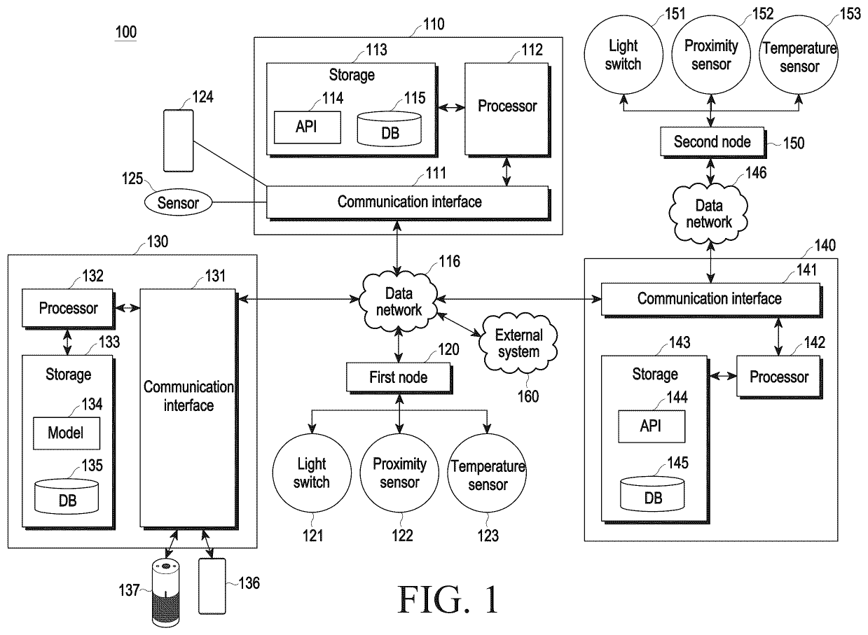

FIG. 1 illustrates an Internet-of-things (IoT) system 100 according to various embodiments. Meanwhile, at least some of the components in FIG. 1 may be omitted, and components not illustrated therein may be implemented to be further included.

Referring to FIG. 1, the IoT system 100 according to an embodiment may include multiples electronic device that are connectable to a data network 116 or 146. For example, the IoT system 100 may include at least one of a first IoT server 110, a first node 120, a voice assistance server 130, a second IoT server 140, a second node 150, or devices 121,122,123,124,125,136,137,151,152, and 153.

According to an embodiment, the first IoT server 110 may include at least one of a communication interface 111, a processor 112, or a storage unit 113. The second IoT server 140 may include at least one of a communication interface 141, a processor 142, or a storage unit 143. As used herein, the “IoT server” may remotely control and/or monitor one or more devices (for example, devices 121,122,123,124,125,151,152, and 153) through a relay device (for example, the first node 120 or the second node 150), or directly without the delay device, based on a data network (for example, the data network 116 or the data network 146). As used herein, “devices” may refer to sensors, electronic devices for domestic/business use, or devices for performing processes, which are disposed (or positioned) in local environments such as houses, offices, factories, buildings, external spots, or other types of sites, for example, and the type thereof is not limited. A device configured to receive a control command and to perform an operation corresponding to the control command may be referred to as a “target device.” The IoT server may also be referred to as a central server in that the same selects a target device from multiple devices and provides a control commands.

According to an embodiment, the first IoT server 110 may communicate with the devices 121, 122, and 123 through the data network 116. The data network 116 may refer to, for example, the Internet or a network for long-range communication such as a computer network (for example, LAN or WAN), or may include a cellular network.

According to an embodiment, the first IoT server 110 may be connected to the data network 116 through the communication interface 111. The communication interface 111 may include a communication device (or communication module) for supporting communication with the data network 116, and may be integrated into one component (for example, single chip) or may be implemented as separate multiple components (for example, multiple chips). The first IoT server 110 may communicate with the devices 121, 122, and 123 through the first node 120. The first node 120 may receive data from the first IoT server 110 through the data network 116, and may transmit the received data to at least some of the devices 121, 122, and 123. Alternatively, the first node 120 may receive data from at least some of the devices 121, 122, and 123, and may transmit the received data to the first IoT server 110 through the data network 116. The first node 120 may function as a bridge between the data network 116 and the devices 121, 122, and 123. Meanwhile, although one first node 120 is illustrated in FIG. 1, this is only an example, and the number thereof is not limited.

As used herein, “node” may refer to an edge computing device or a hub device. According to an embodiment, the first node 120 may support wired and/or wireless communication of the data network 116, and may also support wired and/or wireless communication with the devices 121, 122, and 123. For example, the first node 120 may be connected to the devices 121, 122, and 123 through a short-range communication network such as at least one of Bluetooth, Wi-Fi, Wi-Fi direct, Z-wave, Zigbee, INSETEON, X10, or infrared data association (IrDA), but the communication type is not limited. The first node 120 may be disposed (or positioned) in environments such as houses, offices, factories, buildings, external spots, or other types of sites. Accordingly, the devices 121, 122, and 123 may be monitored and/or controlled by services provided by the first IoT server 110, and the devices 121, 122, and 123 may not be required to have the capability of full network communication (for example, Internet communication) for direct connection to the first IoT server 110. Although the devices 121, 122, and 123 are illustrated as being implemented as electronic devices in indoor environments, such as a lamp switch, a proximity sensor, a temperature sensor, for example, this is exemplary and is not limitative.

According to an embodiment, the first IoT server 110 may support direct communication with the devices 124 and 125. As used herein, “direction communication” may refer to communication which is not conducted through a relay device such as the first node 120, for example, and may be communication through a cellular communication network and/or a data network, for example.

According to an embodiment, the first IoT server 110 may transmit a control command to at least some of the devices 121,122,123,124, and 125. As used herein, “control command” may refer to a data which causes a controllable device to perform a specific operation, the specific operation may include operations performed by the device, such as output of information, sensing of information, reporting of information, management (for example, deletion or generation) of information, and the type thereof is not limited. For example, the processor 112 may acquire information (or a request) for generating a control command from the outside (for example, at least some of the voice assistance server 130, the second IoT server 140, the external system 160, or the devices 121,122,123,124, and 125), and may generate a control command, based on the acquired information. Alternatively, the processor 112 generate a control command, based on a designated condition being satisfied by the result of monitoring at least some of the devices 121,122,123,124, and 125. The processor 112 may control the communication interface 111 such that the control command is transmitted to a target device.

According to an embodiment, the processor 112, the processor 132, or the processor 142 may be implemented as a combination of one or more from among a versatile processor such as a central processing unit (CPU), a digital signal processor (DSP), an application processor (AP), or a communication processor (CP), a dedicated graphics processor such as a graphical processing unit (GPU), or a vision processing unit (VPU), or a dedicated AI processor such as a neural processing unit (NPU). The above-described processing unit is only an example, and those skilled in the art will understand that the processor 112 is not limited as long as the same is a computing means capable of executing instructions stored in memory 113, for example, and outputting the result of execution.

Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the processor 112 may configure a web-based interface, based on the API 114, or may expose resources managed by the first IoT server 110 to the outside. The web-based interface may support communication between the first IoT server 110 and an external web service, for example. The processor 112 may allow the external system 160, for example, to control and/or access the devices 121, 122, and 123. The external system 160 may be an independent system, for example, which is not associated with the system 100, or which is not a part of the system 100. The external system 160 may be an external server, for example, or a web side. However, security is needed with regard to the access from the external system 160 to the devices 121, 122, and 123, or to resources of the first IoT server 110. According to an embodiment, the processor 112, specifically, automation application may expose an API end point (for example, universal resource locator (URL)) based on the API 114 to the outside. As described above, the first IoT server 110 may transfer a control command to the target device among the devices 121, 122, and 123. Meanwhile, descriptions regarding the communication interface 141 of the second IoT sever 140, the processor 142, the API 144 of the storage unit 143, and the database 145 may be substantially identical to descriptions regarding the communication interface 111 of the first IoT sever 110, the processor 112, the API 114 of the storage unit 113, and the database 115. Moreover, descriptions regarding the second node 150 may be substantially identical to descriptions regarding the first node 120. The second server IoT 140 may transfer a control command to a target device among the devices 151, 152, and 153. The first IoT server 110 and the second IoT server 140 may be operated by the same service provider in an embodiment, but may be operated by different services operators, respectively, in another embodiment.

According to an embodiment, the voice assistance server 130 may transmit/receive data with the first IoT server 110 through the data network 116. According to an embodiment, the voice assistance server 130 may include at least one of a communication interface 131, a processor 132, or a storage unit 133. The communication interface 131 may communicate with the smartphone 136 or AI speaker 137 through a data network (not illustrated) and/or a cellular network (not illustrated). The smartphone 136 or AI speaker 137 may include a microphone, may acquire a user voice, may convert the same into a voice signal, and may transmit the voice signal to the voice assistance server 130. The processor 132 may receive the voice signal from the smartphone 136 or AI speaker 137 through the communication interface 131. The processor 132 may process the received voice signal, based on the stored model 134. The processor 132 may generate (or identify) a control command by using the processing result, based on information stored in the database 135. According to an embodiment, the storage unit 113, 133, or 143 may include at least one type of non-transitory storage medium from among a flash memory type, a hard disk type, a multimedia card micro type, card-type memory (for example, SD or XD memory or the like), random access memory (RAM), static random access memory (SRAM), read-only memory (ROM), electrically erasable programmable read-only memory (EEPROM), programmable read-only memory (PROM), magnetic memory, magnetic disk, or an optical disk, and the type thereof is not limited.

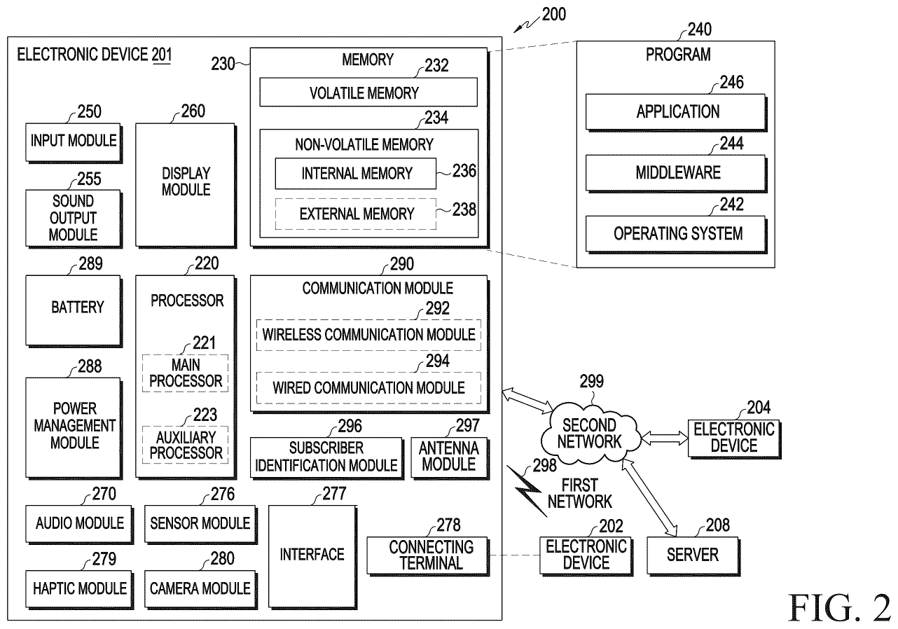

In various embodiments, at least one device (for example, device 124) that communicates with the first IoT server 110 may be a smartphone (for example, the electronic device 201 in FIG. 2) in the network environment.

FIG. 2 is a block diagram illustrating an electronic device 201 in a network environment 200 according to various embodiments.

Referring to FIG. 2, the electronic device 201 in the network environment 200 may communicate with an electronic device 202 via a first network 298 (e.g., a short-range wireless communication network), or at least one of an electronic device 204 or a server 208 via a second network 299 (e.g., a long-range wireless communication network). According to an embodiment, the electronic device 201 may communicate with the electronic device 204 via the server 208. According to an embodiment, the electronic device 201 may include a processor 220, memory 230, an input module 250, a sound output module 255, a display module 260, an audio module 270, a sensor module 276, an interface 277, a connecting terminal 278, a haptic module 279, a camera module 280, a power management module 288, a battery 289, a communication module 290, a subscriber identification module (SIM) 296, or an antenna module 297. In some embodiments, at least one of the components (e.g., the connecting terminal 278) may be omitted from the electronic device 201, or one or more other components may be added in the electronic device 201. In some embodiments, some of the components (e.g., the sensor module 276, the camera module 280, or the antenna module 297) may be implemented as a single component (e.g., the display module 260).

The processor 220 may execute, for example, software (e.g., a program 240) to control at least one other component (e.g., a hardware or software component) of the electronic device 201 coupled with the processor 220, and may perform various data processing or computation. According to an embodiment, as at least part of the data processing or computation, the processor 220 may store a command or data received from another component (e.g., the sensor module 276 or the communication module 290) in volatile memory 232, process the command or the data stored in the volatile memory 232, and store resulting data in non-volatile memory 234. According to an embodiment, the processor 220 may include a main processor 221 (e.g., a central processing unit (CPU) or an application processor (AP)), or an auxiliary processor 223 (e.g., a graphics processing unit (GPU), a neural processing unit (NPU), an image signal processor (ISP), a sensor hub processor, or a communication processor (CP)) that is operable independently from, or in conjunction with, the main processor 221. For example, when the electronic device 201 includes the main processor 221 and the auxiliary processor 223, the auxiliary processor 223 may be adapted to consume less power than the main processor 221, or to be specific to a specified function. The auxiliary processor 223 may be implemented as separate from, or as part of the main processor 221.

The auxiliary processor 223 may control at least some of functions or states related to at least one component (e.g., the display module 260, the sensor module 276, or the communication module 290) among the components of the electronic device 201, instead of the main processor 221 while the main processor 221 is in an inactive (e.g., sleep) state, or together with the main processor 221 while the main processor 221 is in an active state (e.g., executing an application). According to an embodiment, the auxiliary processor 223 (e.g., an image signal processor or a communication processor) may be implemented as part of another component (e.g., the camera module 280 or the communication module 290) functionally related to the auxiliary processor 223. According to an embodiment, the auxiliary processor 223 (e.g., the neural processing unit) may include a hardware structure specified for artificial intelligence model processing. An artificial intelligence model may be generated by machine learning. Such learning may be performed, e.g., by the electronic device 201 where the artificial intelligence is performed or via a separate server (e.g., the server 208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 230 may store various data used by at least one component (e.g., the processor 220 or the sensor module 276) of the electronic device 201. The various data may include, for example, software (e.g., the program 240) and input data or output data for a command related thereto. The memory 230 may include the volatile memory 232 or the non-volatile memory 234.

The program 240 may be stored in the memory 230 as software, and may include, for example, an operating system (OS) 242, middleware 244, or an application 246.

The input module 250 may receive a command or data to be used by another component (e.g., the processor 220) of the electronic device 201, from the outside (e.g., a user) of the electronic device 201. The input module 250 may include, for example, a microphone, a mouse, a keyboard, a key (e.g., a button), or a digital pen (e.g., a stylus pen).

The sound output module 255 may output sound signals to the outside of the electronic device 201. The sound output module 255 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 260 may visually provide information to the outside (e.g., a user) of the electronic device 201. The display module 260 may include, for example, a display, a hologram device, or a projector and control circuitry to control a corresponding one of the display, hologram device, and projector. According to an embodiment, the display module 260 may include a touch sensor adapted to detect a touch, or a pressure sensor adapted to measure the intensity of force incurred by the touch.

The audio module 270 may convert a sound into an electrical signal and vice versa. According to an embodiment, the audio module 270 may obtain the sound via the input module 250, or output the sound via the sound output module 255 or a headphone of an external electronic device (e.g., an electronic device 202) directly (e.g., wiredly) or wirelessly coupled with the electronic device 201.

The sensor module 276 may detect an operational state (e.g., power or temperature) of the electronic device 201 or an environmental state (e.g., a state of a user) external to the electronic device 201, and then generate an electrical signal or data value corresponding to the detected state. According to an embodiment, the sensor module 276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 277 may support one or more specified protocols to be used for the electronic device 201 to be coupled with the external electronic device (e.g., the electronic device 202) directly (e.g., wiredly) or wirelessly. According to an embodiment, the interface 277 may include, for example, a high definition multimedia interface (HDMI), a universal serial bus (USB) interface, a secure digital (SD) card interface, or an audio interface.

A connecting terminal 278 may include a connector via which the electronic device 201 may be physically connected with the external electronic device (e.g., the electronic device 202). According to an embodiment, the connecting terminal 278 may include, for example, a HDMI connector, a USB connector, a SD card connector, or an audio connector (e.g., a headphone connector).

The haptic module 279 may convert an electrical signal into a mechanical stimulus (e.g., a vibration or a movement) or electrical stimulus which may be recognized by a user via his tactile sensation or kinesthetic sensation. According to an embodiment, the haptic module 279 may include, for example, a motor, a piezoelectric element, or an electric stimulator.

The camera module 280 may capture a still image or moving images. According to an embodiment, the camera module 280 may include one or more lenses, image sensors, image signal processors, or flashes.

The power management module 288 may manage power supplied to the electronic device 201. According to an embodiment, the power management module 288 may be implemented as at least part of, for example, a power management integrated circuit (PMIC).

The battery 289 may supply power to at least one component of the electronic device 201. According to an embodiment, the battery 289 may include, for example, a primary cell which is not rechargeable, a secondary cell which is rechargeable, or a fuel cell.

The communication module 290 may support establishing a direct (e.g., wired) communication channel or a wireless communication channel between the electronic device 201 and the external electronic device (e.g., the electronic device 202, the electronic device 204, or the server 208) and performing communication via the established communication channel. The communication module 290 may include one or more communication processors that are operable independently from the processor 220 (e.g., the application processor (AP)) and supports a direct (e.g., wired) communication or a wireless communication. According to an embodiment, the communication module 290 may include a wireless communication module 292 (e.g., a cellular communication module, a short-range wireless communication module, or a global navigation satellite system (GNSS) communication module) or a wired communication module 294 (e.g., a local area network (LAN) communication module or a power line communication (PLC) module). A corresponding one of these communication modules may communicate with the external electronic device via the first network 298 (e.g., a short-range communication network, such as Bluetooth™, wireless-fidelity (Wi-Fi) direct, or infrared data association (IrDA)) or the second network 299 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 292 may identify and authenticate the electronic device 201 in a communication network, such as the first network 298 or the second network 299, using subscriber information (e.g., international mobile subscriber identity (IMSI)) stored in the subscriber identification module 296.

The wireless communication module 292 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 292 may support a high-frequency band (e.g., the mmWave band) to achieve, e.g., a high data transmission rate. The wireless communication module 292 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 292 may support various requirements specified in the electronic device 201, an external electronic device (e.g., the electronic device 204), or a network system (e.g., the second network 299). According to an embodiment, the wireless communication module 292 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 297 may transmit or receive a signal or power to or from the outside (e.g., the external electronic device) of the electronic device 201. According to an embodiment, the antenna module 297 may include an antenna including a radiating element composed of a conductive material or a conductive pattern formed in or on a substrate (e.g., a printed circuit board (PCB)). According to an embodiment, the antenna module 297 may include a plurality of antennas (e.g., array antennas). In such a case, at least one antenna appropriate for a communication scheme used in the communication network, such as the first network 298 or the second network 299, may be selected, for example, by the communication module 290 (e.g., the wireless communication module 292) from the plurality of antennas. The signal or the power may then be transmitted or received between the communication module 290 and the external electronic device via the selected at least one antenna. According to an embodiment, another component (e.g., a radio frequency integrated circuit (RFIC)) other than the radiating element may be additionally formed as part of the antenna module 297.

According to various embodiments, the antenna module 297 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 201 and the external electronic device 204 via the server 208 coupled with the second network 299. Each of the electronic devices 202 or 204 may be a device of a same type as, or a different type, from the electronic device 201. According to an embodiment, all or some of operations to be executed at the electronic device 201 may be executed at one or more of the external electronic devices 202, 204, or 208. For example, if the electronic device 201 should perform a function or a service automatically, or in response to a request from a user or another device, the electronic device 201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 201. The electronic device 201 may provide the outcome, with or without further processing of the outcome, as at least part of a reply to the request. To that end, a cloud computing, distributed computing, mobile edge computing (MEC), or client-server computing technology may be used, for example. The electronic device 201 may provide ultra low-latency services using, e.g., distributed computing or mobile edge computing. In another embodiment, the external electronic device 204 may include an internet-of-things (IoT) device. The server 208 may be an intelligent server using machine learning and/or a neural network. According to an embodiment, the external electronic device 204 or the server 208 may be included in the second network 299. The electronic device 201 may be applied to intelligent services (e.g., smart home, smart city, smart car, or healthcare) based on 5G communication technology or IoT-related technology.

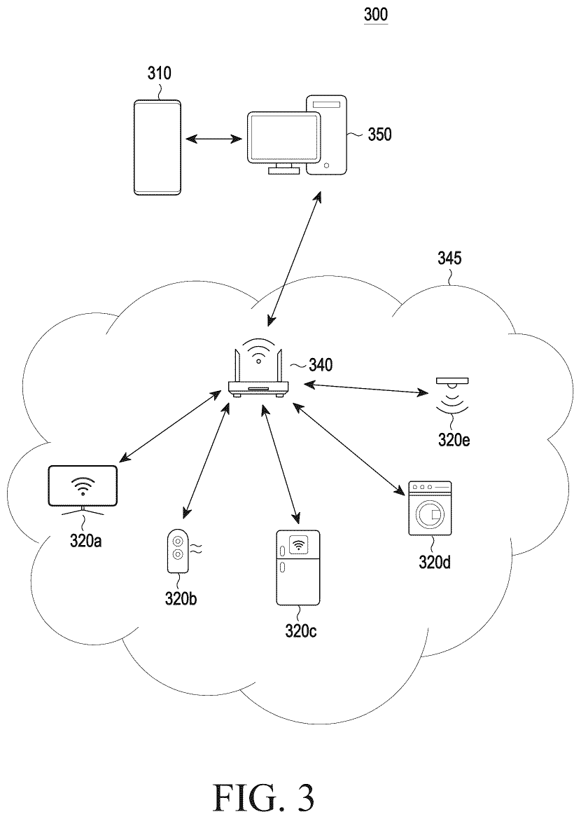

FIG. 3 illustrates a network including controlled devices according to an example embodiment.

Referring to FIG. 3, the network 300 (for example, IoT network) may include a server 350 which operates as an IoT clout and/or account server, a first electronic device 310 (for example, electronic device 201), and one or more controlled devices (for example, IoT devices 320a, 320b, 320c, 320d, and 320e) in the local network 345.

In an embodiment, the first electronic device 310 may be configured to communicate with the server 350 through long-range wireless communication (for example, second network 299). In an embodiment, at least one of the IoT devices 320a, 320b, 320c, 320d, and 320e may be configured to communicate with the first electronic device 310 by using short-range wireless communication (for example, Wi-Fi, Bluetooth legacy, Bluetooth low energy (BLE), ultra-wideband (UWB), and/or near-field communication (NFC)). In an embodiment, at least one of the IoT devices 320a, 320b, 320c, 320d, and 320e may be configured to communicate with the server 350 through the access point (AP) 340 while supporting IoT technology.

In an embodiment, one of the IoT devices 320a, 320b, 320c, 320d, and 320e (for example, IoT device 320a) (for example, TV, home automation panel, personal computer (PC), smartphone, or tablet) may be configured to have a hub function configured to manage the connection and state of the IoT devices 320a, 320b, 320c, 320d, and 320e. The IoT device 320a may communicate with the server 350 through the AP 350, may be onboard similarly to the IoT devices 320a, 320b, 320c, 320d, and 320e, and may then be registered in the server 350.

In an embodiment, the first electronic device 310 may communicate (for example, control or manage) the IoT devices 320a, 320b, 320c, 320d, and 320e through the server 350, through long-range wireless communication (for example, second network 299), or through short-range wireless communication (for example, first network 298).

In an embodiment, the IoT devices 320a, 320b, 320c, 320d, and 320e may include, for example, at least one of a television set, an air conditioner, an air purifier, a refrigerator, a washing machine, a bulb, a security camera, a sensor, or a window treatment. In an embodiment, the IoT devices 320a, 320b, 320c, 320d, and 320e may be configured to be controlled by a remote command (for example, a control command from the first electronic device 310 or the server 350) (for example, configured to report states and/or execute designated actions). In an embodiment, the IoT devices 320a, 320b, 320c, 320d, and 320e may communicate with the first electronic device 310 through the AP 340 in the local network 345, may communicate with the first electronic device 310 through the server 350, and/or communicate with the first electronic device 310 directly (for example, without going through the server 350, the AP 340, or other devices) through a point-to-point (P2P) connection.

In an embodiment, the IoT devices 320a, 320b, 320c, 320d, and 320e may be configured to communicate with the first electronic device 310 through long-range wireless communication (for example, second network 299), or through short-range wireless communication (for example, first network 298). In an embodiment, the IoT devices 320a, 320b, 320c, 320d, and 320e may be configured to communicate with the server 350 through long-range wireless communication (for example, second network 299), or through short-range wireless communication (for example, first network 298).

In an embodiment, at least one of the IoT devices 320a, 320b, 320c, 320d, and 320e may be a hub-connected device which establishes a P2P connection (for example, Bluetooth connection, Bluetooth low energy (BLE) connection, Zigbee connection, ZWave connection, or Wi-Fi connection) with an IoT device (for example, the IoT 320a) operating as a hub, and receives control commands from the server 350 through the IoT 320a or reports states thereto. In an embodiment, at least one of the IoT devices 320a, 320b, 320c, 320d, and 320e may be a cloud-connected device configured to receive control commands from the server 350 through the AP 340 or to report states thereto. In an embodiment, at least one of the IoT devices 320a, 320b, 320c, 320d, and 320e may be a cloud-to-cloud device registered in a third-party cloud and controlled through an inter-cloud application programmable interface (API).

In an embodiment, the first electronic device 310 may be a personal electronic device such as a smartphone or a tablet, for example, or an electronic device having a display and a user interface, such as a television set or a control console. In an embodiment, the first electronic device 310 may be configured to directly perform at least some of functions of the first electronic device 310 described later, or to perform the same through a connection (for example, paring) to at least one external electronic device (for example, a wearable device such as a smart watch).

In an embodiment, the first electronic device 310 may discover at least one of the IoT devices 320a, 320b, 320c, 320d, and 320e, and may execute a procedure (for example, registration procedure) in which the discovered IoT device is registered in the server 350. The IoT devices 320a, 320b, 320c, 320d, and 320e may be registered in the server 350 so as to be associated with the user account, and may be logged in (for example, signed in) with the user account. The first electronic device 310 may monitor and/or control the IoT devices 320a, 320b, 320c, 320d, and 320e, based on the user account. In an embodiment, the first electronic device 310 may identify the state of IoT devices 320a, 320b, 320c, 320d, and 320e to be used by the user for an IoT service, or may control the IoT devices 320a, 320b, 320c, 320d, and 320e (for example, transmit a control command to instruct them to execute a specific action).

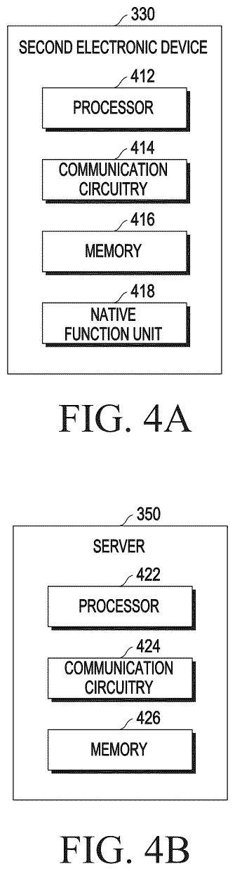

FIG. 4A is a block diagram illustrating the configuration of a second electronic device 330 according to an example embodiment.

Referring to FIG. 4A, the second electronic device 330 may be an IoT device (for example, one of IoT devices 320a, 320b, 320c, 320d, and 320e) configured to perform an IoT service (for example, an event-based IoT service) in an IoT network (for example, network 300). For example, the IoT network may be a smart home network, and the IoT service may be an automation service. The second electronic device 330 may include at least one processor 412 including processing circuitry, communication circuitry 414, memory 416 configured to store instructions, and/or a native function unit 418 configured to perform a native function. Each of the elements 412, 414, 416, and 418 in FIG. 4A may be operatively connected to each other. In an embodiment, the second electronic device 330 may be a TV or a device including a display. In an embodiment, in case that the second electronic device 330 is a smart TV, the native function unit 418 may include TV receiving circuitry and a display. In an embodiment, in case that the second electronic device 330 is a smart washing machine, the native function unit 418 may include a motor and control circuitry. In an embodiment, in case that the second electronic device 330 is a smart refrigerator, the native function unit 418 may include cooling circuitry and control circuitry.

In an embodiment, the communication circuitry 414 may transmit/receive radio signals with an external electronic device (for example, a first electronic device 310, an AP 340, a server 350, and/or other IoT devices). The second electronic device 330 may support a designed short-range wireless communication technology (for example, at least one of Zigbee, Z-Wave, ultra-wideband (UWB), or Wi-Fi) through the communication circuitry 414. The communication circuitry 414 may include one or multiple communication circuits based on the designed short-range wireless communication technology (for example, Zigbee, Z-Wave, UWB, and/or Wi-Fi).

In an embodiment, the processor 412 may be implemented as one or at least two single-core processors, or one or at least two multi-core processors. In an embodiment, the memory 416 may store data and instructions for operations of the second electronic device 330.

In an embodiment, the memory 416 may store relevant information and/or data for controlling accessibility settings sharing according to certain example embodiments. In an embodiment, the memory 416 may store an accessibility feature list (for example, second accessibility feature list) indicating accessibility features currently used by the second electronic device 330.

In an embodiment, the processor 412 may control or manage the state of the second electronic device 330 related to an IoT service (for example, accessibility settings state), and actions (for example, accessibility features). In an embodiment, the processor 412 may receive a control command related to control of the second electronic device 330 from the first electronic device 310 and/or the server 350, and may operate according to the control command. In an embodiment, the control command may be received through the AP 340. In an embodiment, the control command may include an accessibility settings indication which indicates at least one accessibility feature to be applied to the second electronic device 330.

FIG. 4B is a block diagram illustrating the configuration of a server 350 configured to perform IoT control according to an example embodiment.

Referring to FIG. 4B, the server 350 may control and manage components (for example, IoT devices 320a, 320b, 320c, 320d, and 320e and a first electronic device 310) configured to perform an IoT service (for example, event-based IoT service) in an IoT network (for example, a network 300). In an embodiment, the server 350 may be configured to communicate with the IoT devices 320a, 320b, 320c, 320d, and 320e and the first electronic device 310 through an external network (for example, the Internet). In an embodiment, the server 350 may include at least one processor 422 including processing circuitry, communication circuitry 424, and/or memory 426 configured to store instructions. Each of the elements 422, 424, and 426 in FIG. 4B may be operatively connected to each other.

In an embodiment, the communication circuitry 424 may transmit/receive data and control messages with an external electronic device (for example, the first electronic device 310 and/or the IoT devices 320a, 320b, 320c, 320d, and 320e). In an embodiment, the processor 422 may be implemented as one or at least two single-core processors, or one or at least two multi-core processors. In an embodiment, the memory 426 may store data and instructions for operations of the server 350.

In an embodiment, the memory 426 may store relevant information and/or data for controlling accessibility settings sharing according to certain example embodiments. In an embodiment, the memory 426 may store information regarding accessibility features currently used by the first electronic device 310 and information regarding accessibility features currently used by the second electronic device 330.

In an embodiment, the processor 422 may control or manage the state (for example, accessibility settings state) of devices (for example, the first electronic device 310 and the second electronic device 330) related to an IoT service, and actions (for example, accessibility features). In an embodiment, the processor 422 may receive information (for example, accessibility feature lists) related to control of the first electronic device 310 and the second electronic device 330 from the first electronic device 310 and/or the second electronic device 330, may determine accessibility settings sharing, based on the received information, and may transmit a control command including an accessibility settings indication according to the determination to the second electronic device 330. The control command may be transferred to the second electronic device 330 through the AP 340. The accessibility settings indication may indicate at least one accessibility feature to be applied to the second electronic device 330.

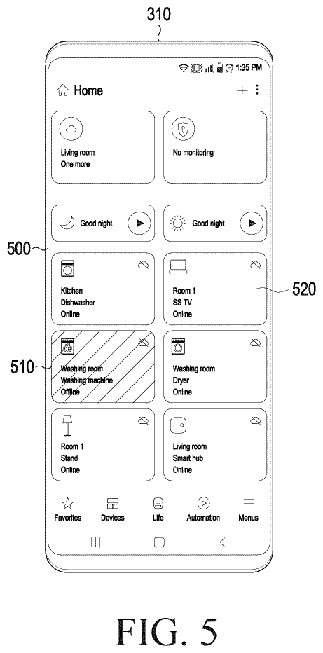

FIG. 5 illustrates an IoT client application's execution screen according to an embodiment.

Referring to FIG. 5, the first electronic device 310 may execute a client application for an IoT control service, and may display an execution screen 500 provided by the client application through a display module (for example, display module 260). The execution screen 500 may include state objects (for example, state objects 510 and 520) indicating states (for example, at least one of an image, a position, a name, or a connection state) of at least one onboarded external electronic device (for example, IoT devices 320a, 320b, 320c, 320d, and 320e). The connection state may include an online or offline state.

In an embodiment, in case that one (for example, washing machine) of the IoT devices 320a, 320b, 320c, 320d, and 320e is not normally connected to the server 350, the state object 510 corresponding to the washing machine may indicate an offline state. In an embodiment, in case that one (for example, master bedroom TV) of the IoT devices 320a, 320b, 320c, 320d, and 320e is normally connected to the server 350, the state object 520 corresponding to the master bedroom TV may indicate an online state. In an embodiment, the IoT devices 320a, 320b, 320c, 320d, and 320e may log in (for example, sign in) to the server 350 by using the user account in an online state.

In an embodiment, the first electronic device 310 and/or the second electronic device 330 (for example, IoT device) may provide accessibility features designed such that people with disabilities can use technologies more easily. For example, by using a test-to-speech feature, texts displayed on the first electronic device 310 may be read loudly to a visually disabled person, and a speech-recognition feature may enable to a user having difficulty moving around to control the first electronic device 310 with his/her voice.

In an embodiment, the first electronic device 310 may turn on (for example, activate or enable) at least one of multiple accessibility features according to user settings. In an embodiment, accessibility features provided by the first electronic device 310 may include at least one of a talkback feature, a voice access feature, a magnification feature, a high contrast screen feature, a black-and-white screen feature, a relumino outline feature, an audio description feature, or a live caption feature.

The talkback feature may be used to read texts displayed on the screen (for example, the display module 260 in FIG. 2) of the first electronic device 310, or to output a voice guidance each time a user gesture (for example, touch) is detected.

The voice access feature may be used to open an application with a voice, to tap a button, input texts, or to perform other tasks.

The magnification feature may be used to adjust the font size, to zoom the screen, or to use the screen of the first electronic device 310 as a magnifier.

The high contrast screen feature may make texts appear more vivid in the background, thereby improving the screen's readability.

The black-and-white screen feature may switch a color screen to a black-and-white screen.

The relumino outline feature may emphasize the screen's outline or the color and brightness contrast, thereby improving the visibility of texts and images on the screen.

The audio description feature may read user interfaces including menus, icons, and/or texts.

The live caption feature may provide captions that describe the screen's content.

In an embodiment, the second electronic device 330 (for example, IoT device) may be configured to provide at least one accessibility feature similar to those provided by the first electronic device 310. In an embodiment, accessibility features provided by the second electronic device 330 may include at least one of the following:

The voice control feature enables the user to control the second electronic device 330 through his/her voice commands. In an embodiment, in case that the second electronic device 330 is a TV, the user may change channels or adjust the volume through his/her voice commands.

The voice guidance feature (for example, screen reader feature) may read texts or menu options displayed on the screen of the second electronic device 330.

The high contrast screen feature may increase the screen's contrast such that users with poor eyesight can navigate menus more easily.

The color inversion feature may invert the screen's color.

The black-and-white screen feature may switch a color screen to a black-and-white screen.

The relumino outline feature may increase the screen's contrast and brightness and may emphasize contours of images and figures.

The audio description feature may provide narration to describe the visual content of moving images.

The closed caption feature may display captions related to the screen.

The zoom feature may magnify on-screen fonts and interface elements.

In an embodiment, in case that the user currently applies (for example, turns on, activates, or enables) accessibility settings corresponding to one or more accessibility features to the first electronic device 310, and in case that the user newly purchases a second electronic device 330 or onboards the same, new accessibility settings corresponding to accessibility features similar to the above accessibility features may be generated with regard to the second electronic device 330. In the process of setting accessibility features of the second electronic device 330, the user may have difficulty in finding and applying desired accessibility features because he/she is not familiar with now to enter accessibility menus.

Certain example embodiments may enable accessibility features that are commonly applicable, regardless of the device model, to be shared between devices (for example, the first electronic device 310 and the second electronic device). According to certain example embodiments, through accessibility settings sharing between the first electronic device 310 and the second electronic device 330, at least one accessibility feature currently used by the first electronic device 310 may be conveniently applied to the second electronic device 330 when logging in to the second electronic device 330.

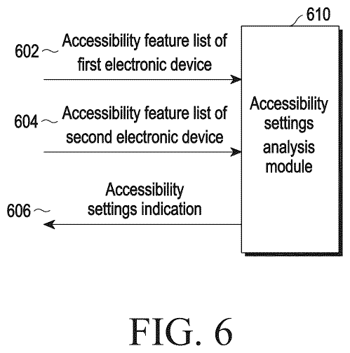

FIG. 6 illustrates a configuration for processing accessibility settings sharing according to an example embodiment.

Referring to FIG. 6, the accessibility settings analysis module 610 may analyze accessibility settings of the first electronic device 310 and may determine accessibility features to be shared with the second electronic device 320. In an embodiment, the accessibility settings analysis module 610 may be included in the server 350, the second electronic device 330, or the first electronic device 310.

In an embodiment, in case of detecting a designated user action, or in case of identifying that, after onboarding of the second electronic device 330, the second electronic device 330 is connected (for example, registered) to the server 350 and/or logged in to the server 350, the first electronic device 310 may provide the accessibility settings analysis module 610 (for example, the server 350 or the second electronic device 330) with an accessibility feature list 602 indicating at least one accessibility feature currently used by the first electronic device 310. In an embodiment, the user action may include at least one of an operation of moving the first electronic device 310 close to the second electronic device 330, an operation of physically contacting (for example, tapping) the first electronic device 310 to the second electronic device 330, a touch onto the screen of the first electronic device 310, or a user input to the screen of the second electronic device 330 or to a button thereof.

In an embodiment, based on identifying that the second electronic device 330 is connected to the server 350 and logged in (for example, signed in) thereto, the first electronic device 310 may transmit an accessibility feature list 602 indicating the accessibility settings state of the first electronic device 310 to the accessibility settings analysis module 610 (for example, the server 350 or the second electronic device 330). In an embodiment, the first electronic device 310 may transmit the accessibility feature list 602 to the accessibility settings analysis module 610 together user account information.

In an embodiment, in case of detecting a designated user action, or in case of the first connection and/or login to the server 350 after the second electronic device 330 is newly registered or purchased, the second electronic device 330 may provide the accessibility settings analysis module 610 (for example, the server 350) with an accessibility feature list 604 indicating at least one accessibility feature currently used by the second electronic device 330.

In an embodiment, the accessibility settings analysis module 610 may identify at least one accessibility feature currently used by the first electronic device 310, based on the accessibility feature list 602 of the first electronic device 310, and may identify accessibility features which can be commonly used by the first electronic device 310 and the second electronic device 330 among the at least one accessibility feature. In an embodiment, the accessibility settings analysis module 610 may determine at least one accessibility feature (for example, first accessibility feature) which is not currently used by the second electronic device 330 among the accessibility features which can be commonly used, based on the accessibility feature list 604 of the second electronic device 330, and may provide the second electronic device 330 with an accessibility settings indication 606 to indicate that the first accessibility feature is to be applied to the second electronic device 330.

In an embodiment, prior to transmitting the accessibility settings indication 606 to the second electronic device 330, the accessibility settings analysis module 610 may identify a user input which permits application of the first accessibility feature to the second electronic device 330.

In an embodiment, based on logging in with the same user account as the first electronic device 310, the second electronic device 330 may switch to accessibility settings similar to accessibility settings of the first electronic device 310 according to the accessibility settings indication 606. In an embodiment, the second electronic device 330 may instantly apply the accessibility feature based on the accessibility settings indication after completing the onboarding such that the user can conveniently use the second electronic device 330 without performing an accessibility setting procedure regarding the second electronic device 330.

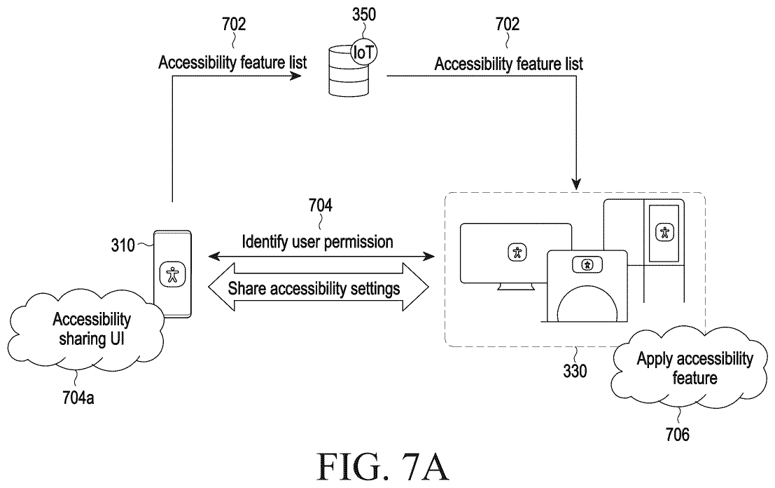

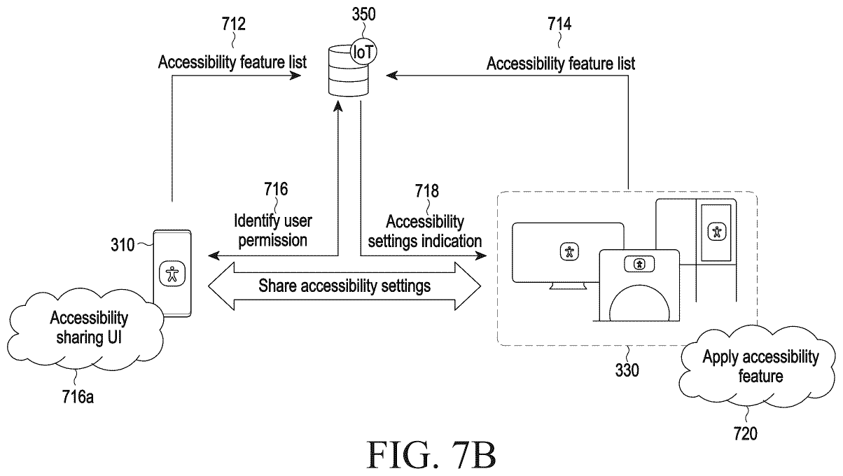

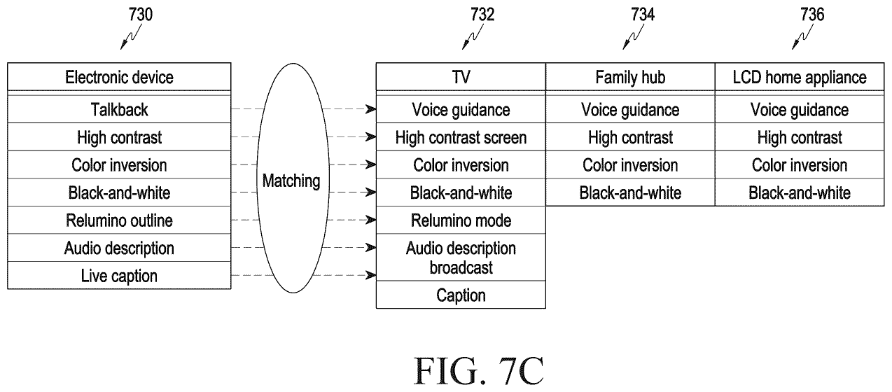

FIG. 7A illustrates a procedure of performing accessibility settings sharing by an IoT device according to an example embodiment.

Referring to FIG. 7A, the first electronic device 310 may transmit a first accessibility feature list (for example, the accessibility feature list 602) indicating at least one accessibility feature (for example, at least one of talkback, high contrast screen, color inversion, black-and-white screen, relumino outline, audio description, or live caption) currently used by the first electronic device 310 to the second electronic device 330 directly or through the server 350 in operation 702.

In an embodiment, the first electronic device 310 may provide the first accessibility feature list, based on receiving information indicating that the second electronic device 330 is logged in after being onboard, is logged in with the same user account as the user account of the first electronic device 310 as a result of account switching, or is logged in for the first time with the same user account as the user account of the first electronic device 310, from the server 350. In an embodiment, the first electronic device 310 may provide the first accessibility feature list, based on detecting a designated user action (for example, a user action for requesting that the first electronic device 310 be connected to the second electronic device 330).

In an embodiment, the first electronic device 310 may transmit the first accessibility feature list to the server 350 each time accessibility settings are changed by the first electronic device 310 such that the server 350 stores the latest version of the first accessibility feature list. In an embodiment, the server 350 may transmit the first accessibility feature list to the second electronic device 330, based on identifying that the second electronic device 330 is logged in with the same user account as the user account of the first electronic device 310, and/or receiving information requesting the first accessibility feature list from the second electronic device 330.

In an embodiment, the second electronic device 330 (for example, one of the IoT devices 320a, 320b, 320c, 320d, and 320e) may determine at least one accessibility feature (for example, first accessibility feature) to be applied to the second electronic device 330, based on the first accessibility feature list.

In operation 704, the second electronic device 330 may transmit accessibility settings sharing information to the first electronic device 310 to inquire whether or not to use the first accessibility feature, and the first electronic device 310 may transmit response information indicating that the user has permitted use of the first accessibility feature to the second electronic device 330. In operation 704a, the first electronic device 310 may display an accessibility settings sharing user interface (UI) for inquiring whether the user permits application of the first accessibility feature to the second electronic device 330 or not, and may transmit the response information, based on receiving a user input indicating that use of the first accessibility feature is permitted through the accessibility settings sharing user interface.

In operation 706, the second electronic device 330 may apply (for example, turn on, activate, or enable) the first accessibility feature, based on receiving the response information.

FIG. 7B illustrates a procedure of performing accessibility settings sharing by a server according to an example embodiment.

Referring to FIG. 7B, the first electronic device 310 may transmit a first accessibility feature list (for example, the accessibility feature list 602) indicating at least one accessibility feature (for example, at least one of talkback, high contrast screen, color inversion, black-and-white screen, relumino outline, audio description, or live caption) currently used by the first electronic device 310 to server 350 in operation 712.

In an embodiment, the first electronic device 310 may provide the first accessibility feature list, based on receiving information indicating that the second electronic device 330 is logged in after being onboard, is logged in with the same user account as the user account of the first electronic device 310 as a result of account switching, or is logged in for the first time with the same user account as the user account of the first electronic device 310, from the server 350. In an embodiment, the first electronic device 310 may provide the first accessibility feature list, based on detecting a designated user action. In an embodiment, the first electronic device 310 may provide the first accessibility feature list, based on a request from the server 350.

In an embodiment, the first electronic device 310 may transmit the first accessibility feature list to the server 350 each time accessibility settings are changed by the first electronic device 310 such that the server 350 stores the first accessibility feature list. In an embodiment, the first electronic device 310 may transmit the first accessibility feature list to the second electronic device 330, based on receiving information which requests the first accessibility feature list from the server 310.

In operation 714, the second electronic device 330 may transmit a second accessibility feature list (for example, the accessibility feature list 604) indicating at least one accessibility feature (for example, at least one of voice guidance, a high contrast screen, color inversion, a black-and-white screen, relumino mode, an audio description broadcast, or captions) currently used by the second electronic device 330 to server 350.

In an embodiment, the second electronic device 330 may provide the second accessibility feature list, based on the second electronic device 330 being logged in after being onboard, being logged in with the same user account as the user account of the first electronic device 310 as a result of account switching, or being logged in for the first time with the same user account as the user account of the first electronic device 310. In an embodiment, the second electronic device 330 may provide the second accessibility feature list, based on detecting a designated user action. In an embodiment, the second electronic device 330 may provide the second accessibility feature list, based on a request from the server 350.

In an embodiment, the server 350 may determine at least one accessibility feature (for example, first accessibility feature) to be applied to the second electronic device 330, among accessibility features currently used by the first electronic device 310, based on the first accessibility feature list and the second accessibility feature list. In an embodiment, the server 350 may determine that the second electronic device 330 is not using all accessibility features in case that the second electronic device 330 is initially onboard, and may determine the first accessibility feature without the second accessibility feature list.

In operation 716, the server 350 may transmit accessibility settings sharing information to the first electronic device to inquire whether or not to use the first accessibility feature, and the first electronic device 310 may transmit response information indicating that the user has permitted use of the first accessibility feature to the server 350. In operation 716a, the first electronic device 310 may display an accessibility settings sharing user interface (UI) for inquiring whether the user permits application of the first accessibility feature to the second electronic device 330 or not, and may transmit the response information, based on receiving a user input indicating that use of the first accessibility feature is permitted through the accessibility settings sharing user interface.

In operation 718, the server 350 may transmit an accessibility settings indication to the second electronic device 330 to indicate that the first accessibility feature is to be applied, based on receiving the response information. In operation 720, the second electronic device 330 may apply (for example, turn on, activate, or enable) the first accessibility feature, based on receiving the accessibility settings indication.

In an embodiment, the accessibility settings analysis module 610 (for example, the second electronic device 330 or the server 350) may determine that, excluding accessibility features customized for the first electronic device 310 among accessibility features that can be used by the first electronic device 310, at least one accessibility feature that can be used by another electronic device (for example, the second electronic device 330) is the target of accessibility settings sharing.

In an embodiment, the accessibility settings analysis module 610 (for example, the second electronic device 330 or the server 350) may determine that, among accessibility features that can be used by the first electronic device 310, at least one accessibility feature deemed to be identical or similar to accessibility features of the second electronic device 330 in terms of user experiences is the accessibility feature that can be commonly used by the first electronic device 310 and the second electronic device 330 (for example, common accessibility feature).

In an embodiment, the accessibility settings analysis module 610 (for example, the second electronic device 330 or the server 350) may match accessibility features of the second electronic device 330, which are identical or similar to accessibility features of the first electronic device 310, to accessibility features of the first electronic device 310 one by one. In an embodiment, the accessibility settings analysis module 610 (for example, the second electronic device 330 or the server 350) may rule out at least one accessibility feature which is identical or similar to accessibility features of the first electronic device 310, but which cannot be applied redundantly.

FIG. 7C illustrates the matching relationship between accessibility features according to an example embodiment.

Referring to FIG. 7C, accessibility features 730 supported by the first electronic device 310 may include at least one of a talkback feature, a high contrast screen feature, a color inversion feature, a black-and-white screen feature, a relumino outline feature, an audio description feature, or a live caption feature. In an embodiment, the first electronic device 310 may activate at least one of the above-described accessibility features.

In an embodiment, in case that the second electronic device 330 is a TV, accessibility features 732 supported by the TV may include at least one of a voice guidance feature, a high contrast screen feature, a color inversion feature, a black-and-white screen feature, a relumino feature, an audio description broadcast feature, or a caption feature. The voice guidance feature, the high contrast screen feature, the color inversion feature, the black-and-white screen feature, the relumino feature, the audio description broadcast feature, and the caption feature of the TV may match with the talkback feature, the high contrast screen feature, the color inversion feature, the black-and-white screen feature, the relumino outline feature, the audio description feature, and the live caption feature of the first electronic device 310, respectively.

In an embodiment, in case that the second electronic device 330 is a family hub or a liquid crystal display (LCD) home appliance, accessibility features 734 or 736 supported by the family hub or LCD home appliance may include at least one of a voice guidance feature, a high contrast screen feature, a color inversion feature, or a black-and-white screen feature. The voice guidance feature, the high contrast screen feature, the color inversion feature, and the black-and-white screen feature of the family hub or LCD home appliance may match with the talkback feature, the high contrast screen feature, the color inversion feature, and the black-and-white screen feature of the first electronic device 310, respectively.

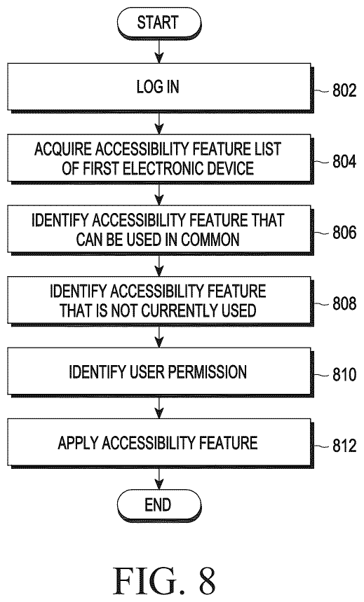

FIG. 8 is a flowchart illustrating a procedure of performing accessibility settings sharing by an IoT device according to an example embodiment. According to embodiments, at least one of the operations described below may be omitted, modified, or executed in a different order. In an embodiment, at least one of the operations described below may be executed by a processor (for example, the processor 412 in FIG. 4A) of an IoT device (for example, the second electronic device 330). In an embodiment, the memory (for example, the memory 416 in FIG. 4A) of the second electronic device 330 may store instructions which cause the second electronic device 330 to operate according to at least one of the operations described below.

Referring to FIG. 8, in operation 802, the second electronic device 330 (for example, processor 412) may connect to the server 350 and may log in (for example, sign in) to the server 350 with a user account. In an embodiment, the second electronic device 330 (for example, processor 412) may connect to the server 350, based on network information (for example, the name and password of an access point (AP)) which has been prestored after onboarding, or which has been provided from an external electronic device (for example, the first electronic device 310), and may log in with the user account. In an embodiment, the second electronic device 330 (for example, processor 412) may log in with the user account, based on execution of an onboarding and/or registration procedure through the first electronic device 310.

In an embodiment, the second electronic device 330 (for example, processor 412) may log in to the server 350, based on a designated user action (for example, a user action for requesting that the first electronic device 310 be connected to the second electronic device). In an embodiment, the user action may include at least one of an operation of detecting the first electronic device 310 approaching the second electronic device 330, an operation of detecting the first electronic device 310 physically contacting (for example, tapping) the second electronic device 330, or reception of a user input (for example, touch) to the screen of the second electronic device 330 or to a button thereof.

In operation 804, the second electronic device 330 (for example, processor 412) may acquire a first accessibility feature list (for example, accessibility feature list 602) indicating at least one accessibility feature currently used by the first electronic device 310. In an embodiment, the second electronic device 330 (for example, processor 412) may directly receive the first accessibility feature list from the first electronic device 310 through a P2P connection (for example, Wi-Fi connection or Bluetooth connection), or may receive the first accessibility feature list from the first electronic device 310 through the server 350.

In operation 806, the second electronic device 330 (for example, processor 412) may identify at least one accessibility feature (for example, common accessibility feature) which can be used by the second electronic device 330 among at least one accessibility feature currently used by the first electronic device 310, based on the first accessibility feature list. In an embodiment, the second electronic device 330 (for example, processor 412) may identify the at least one accessibility feature, based on matching between accessibility features (for example, accessibility features 730) supported by the first electronic device 310 and accessibility features (for example, accessibility features 732, 734, or 736) supported by the second electronic device 330.

In operation 808, the second electronic device 330 (for example, processor 412) may identify at least one accessibility feature (for example, at least one first accessibility feature) which is currently not used by the second electronic device 330 among the at least one common accessibility feature, based on at least one accessibility feature currently used by the second electronic device 330. In an embodiment, the second electronic device 330 (for example, processor 412) may rule out accessibility features already used by the second electronic device 330 among the at least one common accessibility feature.

In operation 810, the second electronic device 330 (for example, processor 412) may identify a user input which permits application of the at least one first accessibility feature to the second electronic device 330. In an embodiment, the second electronic device 330 (for example, processor 412) may identify that the user has permitted application of the at least one first accessibility feature to the second electronic device 330, through the first electronic device 310.

In operation 812, the second electronic device 330 (for example, processor 412) may apply (for example, turn on, activate, or enable) the at least one first accessibility feature to the second electronic device 330. In an embodiment, the second electronic device 330 (for example, processor 412) may display a screen or output a sound in a state in which the at least one first accessibility feature is activated.

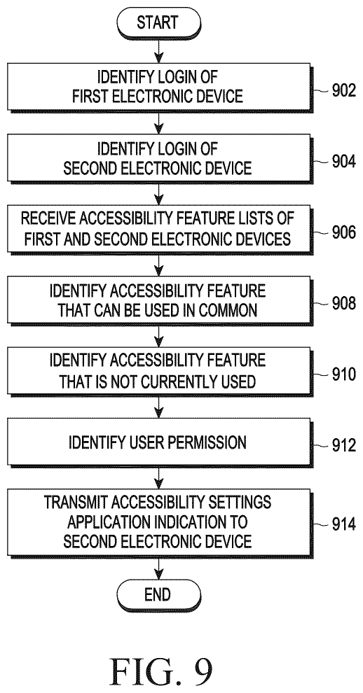

FIG. 9 is a flowchart illustrating a procedure of performing accessibility settings sharing by a server according to an example embodiment. According to embodiments, at least one of the operations described below may be omitted, modified, or executed in a different order. In an embodiment, at least one of the operations described below may be executed by a processor (for example, the processor 422 in FIG. 4B) of the server 350. In an embodiment, the memory (for example, the memory 426 in FIG. 4B) of the server 350 may store instructions which cause the server 350 to operate according to at least one of the operations described below.

Referring to FIG. 9, in operation 902, the server 350 (for example, processor 422) may identify that the first electronic device 310 logs in with a user account. In an embodiment, the first electronic device 310 may log in to the server 350 with a designated user account through execution of a designated application (for example, IoT client application).

In operation 904, the server 350 (for example, processor 422) may identify that the second electronic device 330 logs in with the user account. In an embodiment, the second electronic device 330 may connect to the server 350, based on network information (for example, the name and password of an access point (AP)) which has been prestored after onboarding, or which has been provided from an external electronic device (for example, the first electronic device 310), and may log in to the server 350 with the user account.

In operation 906, the server 350 (for example, processor 422) may receive a first accessibility feature list (for example, accessibility feature list 602) indicating at least one accessibility feature currently used by the first electronic device 310 from the first electronic device 310, and may receive a second accessibility feature list (for example, accessibility feature list 604) indicating at least one accessibility feature currently used by the second electronic device 330 from the second electronic device 330.

In an embodiment, the server 350 (for example, processor 422) may request the first electronic device 310 and second electronic device 330 to provide the first accessibility feature list and the second accessibility feature list, respectively, based on identifying that the second electronic device 330 is logged in. In an embodiment, the server 350 (for example, processor 422) may acquire the first accessibility feature list which has been received in advance from the first electronic device 310 and then stored, from the memory 426. In an embodiment, the server 350 (for example, processor 422) may not receive the second accessibility feature list, based on identifying that the second electronic device 330 is onboard for the first time, and may determine that the second electronic device 330 is not applying all accessibility features.

In operation 908, the server 350 (for example, processor 422) may identify at least one accessibility feature (for example, common accessibility feature) which can be used by the second electronic device 330 among at least one accessibility feature currently used by the first electronic device 310, based on the first accessibility feature list. In an embodiment, the server 350 (for example, processor 422) may identify the at least one accessibility feature, based on matching between accessibility features (for example, accessibility features 730) supported by the first electronic device 310 and accessibility features (for example, accessibility features 732, 734, or 736) supported by the second electronic device 330.

In operation 910, the server 350 (for example, processor 422) may identify at least one accessibility feature (for example, at least one first accessibility feature) which is currently not used by the second electronic device 330 among the at least one common accessibility feature, based on at least one accessibility feature (for example, second accessibility feature list) currently used by the second electronic device 330. In an embodiment, the server 350 (for example, processor 422) may rule out accessibility features already used by the second electronic device 330 among the at least one common accessibility feature.

In operation 912, the server 350 (for example, processor 422) may identify a user input which permits application of the at least one first accessibility feature to the second electronic device 330. In an embodiment, the server 350 (for example, processor 422) may identify that the user has permitted application of the at least one first accessibility feature to the second electronic device 330, through the first electronic device 310.

In operation 914, the server 350 (for example, processor 422) may transmit an accessibility settings indication to the second electronic device 330 to indicate that the at least one first accessibility feature is to be applied (for example, turned on, activated, or enabled) to the second electronic device 330. In an embodiment, the accessibility settings indication may be transmitted to the second electronic device 330 through the Internet, or transmitted to the second electronic device 330 through the first electronic device 310. In an embodiment, the second electronic device 330 (for example, processor 412) may display a screen or output a sound in a state in which the at least one first accessibility feature is activated, based on receiving the accessibility settings indication.

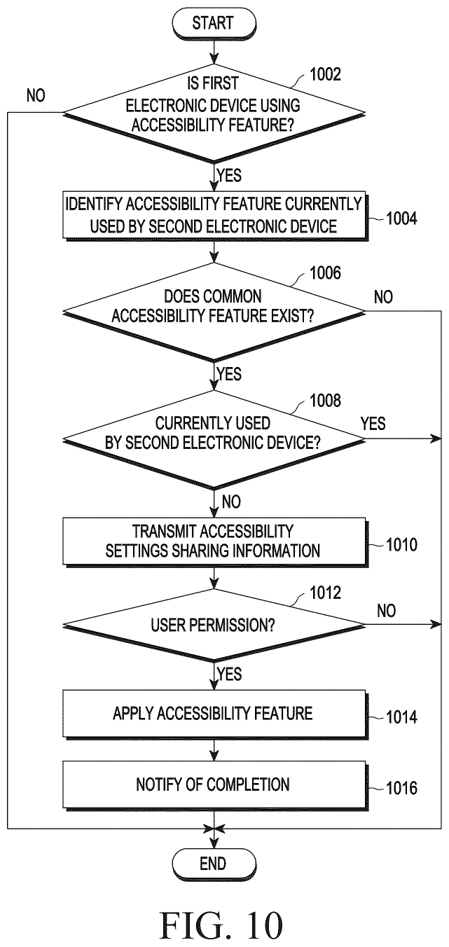

FIG. 10 is a flowchart illustrating a procedure of analyzing accessibility settings according to an example embodiment. According to embodiments, at least one of the operations described below may be omitted, modified, or executed in a different order. In an embodiment, at least one of the operations described below may be executed by the accessibility settings analysis module 610 (for example, the processor 412 of the second electronic device 330 or the processor 422 of the server 350). In an embodiment, the memory (for example, the memory 416 in FIG. 4A) of the second electronic device 330 or the memory (for example, the memory 426 in FIG. 4B) of the server 350 may store instructions which cause the second electronic device 330 or the server 350 to operate according to at least one of the operations described below.

Referring to FIG. 10, in operation 1002, the accessibility settings analysis module 610 (for example, the processor 412 of the second electronic device 330 or the processor 422 of the server 350) may determine whether the first electronic device 310 is currently using at least one accessibility feature, based on a first accessibility feature list (for example, the accessibility feature list 602) received from the first electronic device 310. The procedure may be ended in case that the first electronic device 310 is not currently using at least one accessibility feature. In case that the first electronic device 310 is currently using at least one accessibility feature, the accessibility settings analysis module 610 (for example, the processor 412 of the second electronic device 330 or the processor 422 of the server 350) may proceed to operation 1004.

In operation 1004, the accessibility settings analysis module 610 (for example, the processor 412 of the second electronic device 330 or the processor 422 of the server 350) may identify at least one accessibility feature currently used by the second electronic device 330. In an embodiment, the accessibility settings analysis module 610 (for example, the processor 412 of the second electronic device 330 or the processor 422 of the server 350) may identify at least one accessibility feature currently used by the second electronic device 330, based on a second accessibility feature list (for example, the accessibility feature list 604) related to the second electronic device 330, or may identify that the second electronic device 330 is not currently using all accessibility features. In an embodiment, the accessibility settings analysis module 610 (for example, the processor 412 of the second electronic device 330 or the processor 422 of the server 350) may determine that the second electronic device 330 is not currently using all accessibility features in case that the second electronic device 330 is onboard for the first time.

In operation 1006, the accessibility settings analysis module 610 (for example, the processor 412 of the second electronic device 330 or the processor 422 of the server 350) may determine whether there is an accessibility feature (for example, common accessibility feature) which can be used by the second electronic device 330, among at least one accessibility feature included in the first accessibility feature list. The procedure may be ended in case that no common accessibility feature exists. In case that the common accessibility feature exists, the accessibility settings analysis module 610 (for example, the processor 412 of the second electronic device 330 or the processor 422 of the server 350) may proceed to operation 1008.

In operation 1008, the accessibility settings analysis module 610 (for example, the processor 412 of the second electronic device 330 or the processor 422 of the server 350) may determine whether the common accessibility feature is already used (for example, currently used) by the second electronic device 330 or not. The procedure may be ended in case that the common accessibility feature is already used. In case that the common accessibility feature is not currently used, the accessibility settings analysis module 610 (for example, the processor 412 of the second electronic device 330 or the processor 422 of the server 350) may proceed to operation 1010.

In operation 1010, the accessibility settings analysis module 610 (for example, the processor 412 of the second electronic device 330 or the processor 422 of the server 350) may transmit accessibility settings sharing information indicating the common accessibility feature to the first electronic device 310. The accessibility settings sharing information may cause the first electronic device 310 to display an accessibility settings sharing user interface to inquire whether application of the common accessibility feature to the second electronic device 330 is permitted or not.

In operation 1012, the accessibility settings analysis module 610 (for example, the processor 412 of the second electronic device 330 or the processor 422 of the server 350) may identify whether response information indicating that a user input that permits application of the common accessibility feature to the second electronic device 330 has been received from the first electronic device 310 has been received or not. The procedure may be ended in case that the user has not permitted application of the common accessibility feature to the second electronic device 330. In case that the user has permitted application of the common accessibility feature to the second electronic device 330, the accessibility settings analysis module 610 (for example, the processor 412 of the second electronic device 330 or the processor 422 of the server 350) may proceed to operation 1014.

In operation 1014, the accessibility settings analysis module 610 (for example, the processor 412 of the second electronic device 330 or the processor 422 of the server 350) may apply the common accessibility feature to the second electronic device 330. In an embodiment, the server 350 (for example, the processor 422) may transmit an accessibility settings indication to the second electronic device 330 to indicate that the common accessibility feature is to be applied.

In operation 1016, the accessibility settings analysis module 610 (for example, the processor 412 of the second electronic device 330 or the processor 422 of the server 350) may provide a notification (for example, visual or auditory information) indicating that the common accessibility feature has been applied to the second electronic device 330. In an embodiment, the accessibility settings analysis module 610 (for example, the processor 412 of the second electronic device 330 or the processor 422 of the server 350) may cause the first electronic device 310 to output (for example, display) the notification.

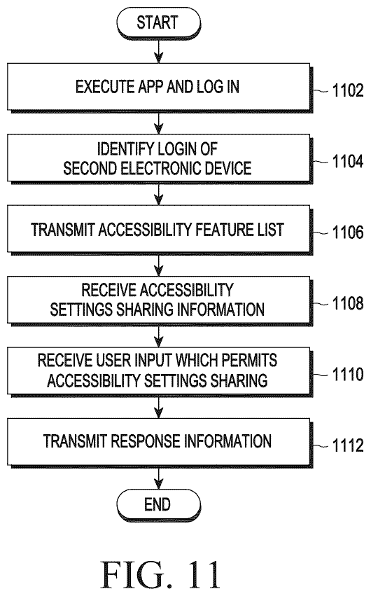

FIG. 11 illustrates a procedure of permitting accessibility settings sharing according to an example embodiment. According to embodiments, at least one of the operations described below may be omitted, modified, or executed in a different order. In an embodiment, at least one of the operations described below may be executed by the processor (for example, the processor 220 in FIG. 2) of the first electronic device 310 (for example, the electronic device 201 in FIG. 2). In an embodiment, the memory (for example, the memory 230 in FIG. 2) of the first electronic device 310 may store instructions which cause the first electronic device 310 to operate according to at least one of the operations described below.

Referring to FIG. 11, in operation 1102, the first electronic device 310 (for example, the processor 220) may execute an IoT client application and may log in (for example, sign in) to the server 350 with a user account through the IoT client application.

In operation 1104, the first electronic device 310 (for example, the processor 220) may identify that the second electronic device 330 logs in to the server 350 with the same user account. In an embodiment, the first electronic device 310 (for example, the processor 220) may recognize the login of the second electronic device 330, based on a procedure of onboarding and registration of the second electronic device 330 being conducted through the IoT client application. In an embodiment, the first electronic device 310 (for example, the processor 220) may recognize the login of the second electronic device 330, based on receiving information (for example, user account information) indicating that the second electronic device 330 logs in, from the second electronic device 330 or the server 350.

In an embodiment, the first electronic device 310 (for example, the processor 220) may conduct the procedure of onboarding and registration of the second electronic device 330, based on detecting a designated user action (for example, a user action for requesting that the first electronic device 310 be connected to the second electronic device 330), and may recognize the login of the second electronic device 330. In an embodiment, the user action may include at least one of an operation of detecting the first electronic device 310 approaching the second electronic device 330, an operation of detecting the first electronic device 310 physically contacting (for example, tapping) the second electronic device 330, or reception of a user input (for example, touch) to the screen of the second electronic device 330 or to a button thereof.

In operation 1106, the first electronic device 310 (for example, the processor 220) may transmit a first accessibility feature list (for example, accessibility feature list 604) indicating at least one accessibility feature currently used by the first electronic device 310 to the server 350 or the second electronic device 330. In an embodiment, the first electronic device 310 (for example, the processor 220) may provide the first accessibility feature list, based on identifying that the second electronic device 330 logs in with the same user account. In an embodiment, the first accessibility feature list may be transmitted based on a request from the server 350 or the second electronic device 330. In an embodiment, the first accessibility feature list may be transmitted to the second electronic device 330 directly or through the server 350.

In operation 1108, the first electronic device 310 (for example, the processor 220) may receive accessibility settings sharing information by which the first electronic device 310 indicates at least one accessibility feature (for example, first accessibility feature) from the server 350 or the second electronic device 330. In an embodiment, the accessibility settings sharing information may be received from the second electronic device 330 directly or through the server 350. The first electronic device 310 (for example, the processor 220) may display an accessibility settings sharing user interface for inquiring whether the user permits application of the first accessibility feature to the second electronic device 330 or not, based on the accessibility settings sharing information.

In operation 1110, the first electronic device 310 (for example, the processor 220) may receive a user input which permits application of the first accessibility feature to the second electronic device 330, through the accessibility settings sharing user interface.

In operation 1112, the first electronic device 310 (for example, the processor 220) may transmit response information to the server 350 or the second electronic device 330 to indicate that application of the first accessibility feature to the second electronic device 330 is permitted.

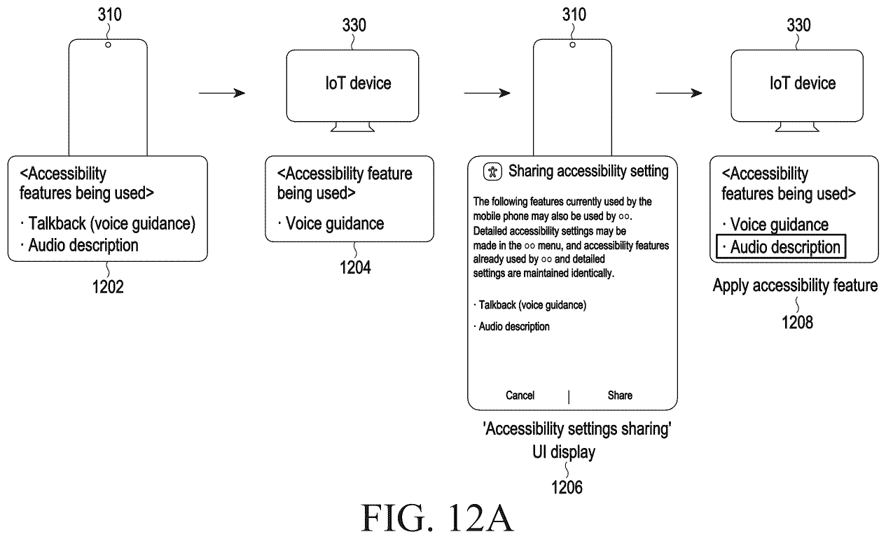

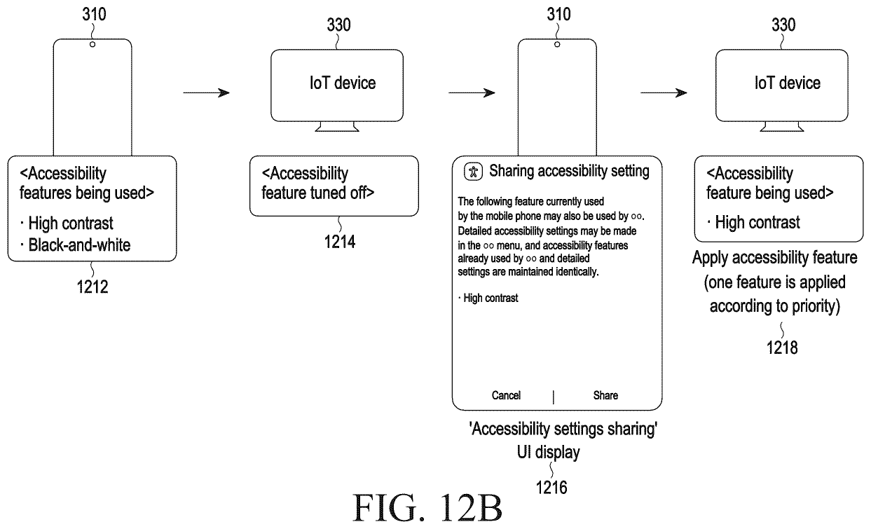

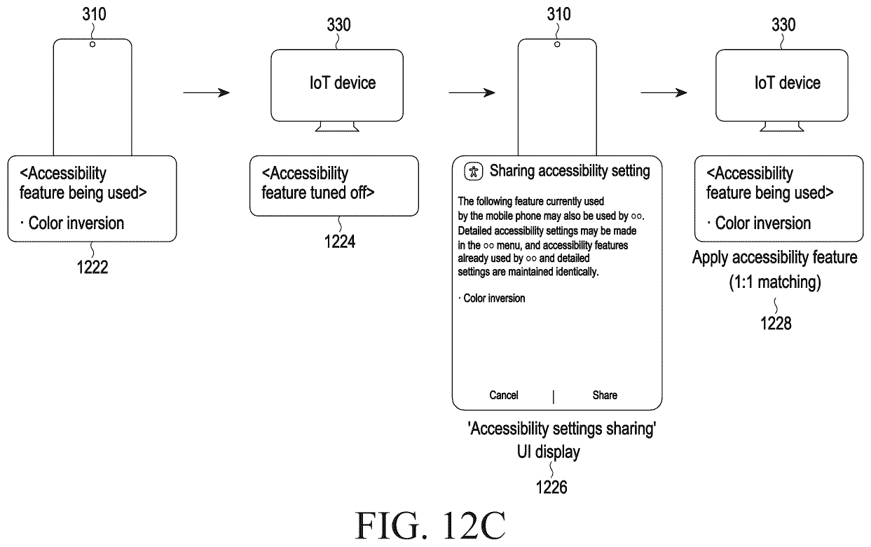

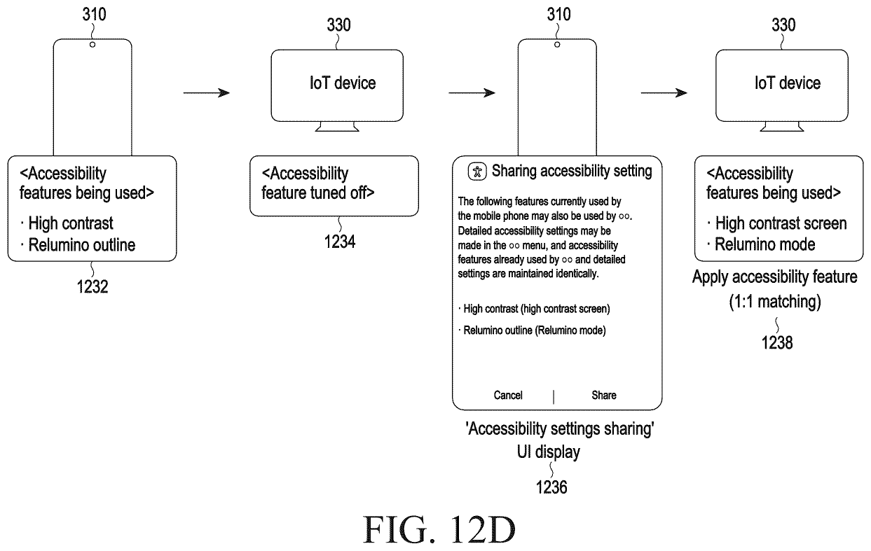

FIG. 12A, FIG. 12B, FIG. 12C, FIG. 12D, and FIG. 12E illustrate accessibility feature matching according to an example embodiment.

Referring to FIG. 12A, in operation 1202, the accessibility settings analysis module 610 (for example, the second electronic device 330 or the server 350) may identify that the first electronic device 310 is using a talkback feature and an audio description feature. In operation 1204, the accessibility settings analysis module 610 (for example, the second electronic device 330 or the server 350) may identify that the second electronic device 330 (for example, TV) is using a voice guidance feature.

In an embodiment, the accessibility settings analysis module 610 (for example, the second electronic device 330 or the server 350) may identify that the talkback feature of the first electronic device 310 matches with the voice guidance feature of the second electronic device 330, and may identify that the audio description feature of the second electronic device 330, which corresponds to the audio description feature of the first electronic device 310, is not being used by the second electronic device 330.

In operation 1206, the first electronic device 310 may display an accessibility settings sharing user interface which notifies that the audio description feature is applied to the second electronic device 330, based on a request (for example, accessibility settings sharing information) of the accessibility settings analysis module 610 (for example, the second electronic device 330 or the server 350). In an embodiment, the accessibility settings sharing user interface may include a phrase notifying that the accessibility feature (for example, audio description feature) currently used by the first electronic device 310 is applied to the second electronic device 330, and an input object (for example, “Share”) for permitting accessibility settings sharing. Based on identifying that a user input (for example, touch) regarding the input object is received, the accessibility settings analysis module 610 (for example, the second electronic device 330 or the server 350) may apply the audio description feature to the second electronic device 330.

In operation 1208, the second electronic device 330 may display a notification screen indicating that a new accessibility feature (for example, audio description feature) is applied. In an embodiment, the second electronic device 330 may display the new accessibility feature (for example, audio description feature) so as to be highlighted (for example, highlighted voice or contour) against the existing accessibility feature (for example, voice guidance feature).

Referring to FIG. 12B, in operation 1212, the accessibility settings analysis module 610 (for example, the second electronic device 330 or the server 350) may identify that the first electronic device 310 is using a high contrast screen feature and a black-and-white screen feature. In operation 1214, the accessibility settings analysis module 610 (for example, the second electronic device 330 or the server 350) may identify that accessibility settings of the second electronic device 330 (for example, TV) are turned off. In an embodiment, the accessibility settings analysis module 610 (for example, the second electronic device 330 or the server 350) may identify that the high contrast screen feature and black-and-white screen feature of the first electronic device 310 are not being used by the second electronic device 330, but may determine to apply the high contrast screen feature to the second electronic device 330 according to a predesignated priority.

In operation 1216, the first electronic device 310 may display an accessibility settings sharing user interface which notifies that the high contrast screen feature is applied to the second electronic device 330, based on a request (for example, accessibility settings sharing information) of the accessibility settings analysis module 610 (for example, the second electronic device 330 or the server 350). In an embodiment, the accessibility settings sharing user interface may include a phrase notifying that the accessibility feature (for example, high contrast screen feature) currently used by the first electronic device 310 is applied to the second electronic device 330, and an input object (for example, “Share”) for permitting accessibility settings sharing. Based on identifying that a user input (for example, touch) regarding the input object is received, the accessibility settings analysis module 610 (for example, the second electronic device 330 or the server 350) may apply the high contrast screen feature to the second electronic device 330.

In operation 1218, the second electronic device 330 may display a notification screen indicating that a new accessibility feature (for example, high contrast screen feature) is applied.

In an embodiment, the accessibility settings analysis module 610 (for example, the second electronic device 330 or the server 350) may select at least one accessibility feature according to a predefined feature-specific priority, among multiple accessibility features currently used by the first electronic device 310, and may determine to apply the same to the second electronic device 330.

In an embodiment, the first electronic device 310 may redundantly use four accessibility features (for example, features A, B, C, and D), but the second electronic device 330 may be able to use only one of features A′, B′, C′, and D′ which are identical or similar to features A, B, C, and D. In an embodiment, the accessibility settings analysis module 610 (for example, the second electronic device 330 or the server 350) may identify priorities of the features A/A′>B/B′>C/C′>D/D′. In an embodiment, the priorities may be in the order of A/A′>B/B′>C/C′>D/D′. In an embodiment, the accessibility settings analysis module 610 (for example, the second electronic device 330 or the server 350) may determine to apply feature A′ among features A′, B′, C′, and D′ to the second electronic device 330 according to the priorities.

Referring to FIG. 12C, in operation 1222, the accessibility settings analysis module 610 (for example, the second electronic device 330 or the server 350) may identify that the first electronic device 310 is using a color inversion feature. In operation 1224, the accessibility settings analysis module 610 (for example, the second electronic device 330 or the server 350) may identify that accessibility settings of the second electronic device 330 (for example, TV) are turned off.

In an embodiment, the accessibility settings analysis module 610 (for example, the second electronic device 330 or the server 350) may identify that the color inversion feature of the second electronic device 330, which corresponds to the color inversion feature of the first electronic device 310, is not being used by the second electronic device 330.

In operation 1226, the first electronic device 310 may display an accessibility settings sharing user interface which notifies that the color inversion feature is applied to the second electronic device 330, based on a request (for example, accessibility settings sharing information) of the accessibility settings analysis module 610 (for example, the second electronic device 330 or the server 350). In an embodiment, the accessibility settings sharing user interface may include a phrase notifying that the accessibility feature (for example, color inversion feature) currently used by the first electronic device 310 is applied to the second electronic device 330, and an input object (for example, “Share”) for permitting accessibility settings sharing. Based on identifying that a user input (for example, touch) regarding the input object is received, the accessibility settings analysis module 610 (for example, the second electronic device 330 or the server 350) may apply the color inversion feature to the second electronic device 330.

In operation 1228, the second electronic device 330 may display a notification screen indicating that a new accessibility feature (for example, color inversion feature) is applied.

Referring to FIG. 12D, in operation 1232, the accessibility settings analysis module 610 (for example, the second electronic device 330 or the server 350) may identify that the first electronic device 310 is using a high contrast screen feature and a relumino outline feature. In operation 1234, the accessibility settings analysis module 610 (for example, the second electronic device 330 or the server 350) may identify that accessibility settings of the second electronic device 330 (for example, TV) are turned off.

In an embodiment, the accessibility settings analysis module 610 (for example, the second electronic device 330 or the server 350) may identify that the high contrast screen feature and the relumino feature of the second electronic device 330, which correspond to the high contrast screen feature and the relumino outline feature of the first electronic device 310, are not being used by the second electronic device 330.

In operation 1236, the first electronic device 310 may display an accessibility settings sharing user interface which notifies that the high contrast screen feature and the relumino feature are applied to the second electronic device 330, based on a request (for example, accessibility settings sharing information) of the accessibility settings analysis module 610 (for example, the second electronic device 330 or the server 350). In an embodiment, the accessibility settings sharing user interface may include a phrase notifying that the accessibility features (for example, the high contrast screen feature and the relumino feature) currently used by the first electronic device 310 are applied to the second electronic device 330, and an input object (for example, “Share”) for permitting accessibility settings sharing. Based on identifying that a user input (for example, touch) regarding the input object is received, the accessibility settings analysis module 610 (for example, the second electronic device 330 or the server 350) may apply the high contrast screen feature and the relumino feature to the second electronic device 330.

In operation 1238, the second electronic device 330 may display a notification screen indicating that new accessibility features (for example, high contrast screen feature and relumino feature) are applied.

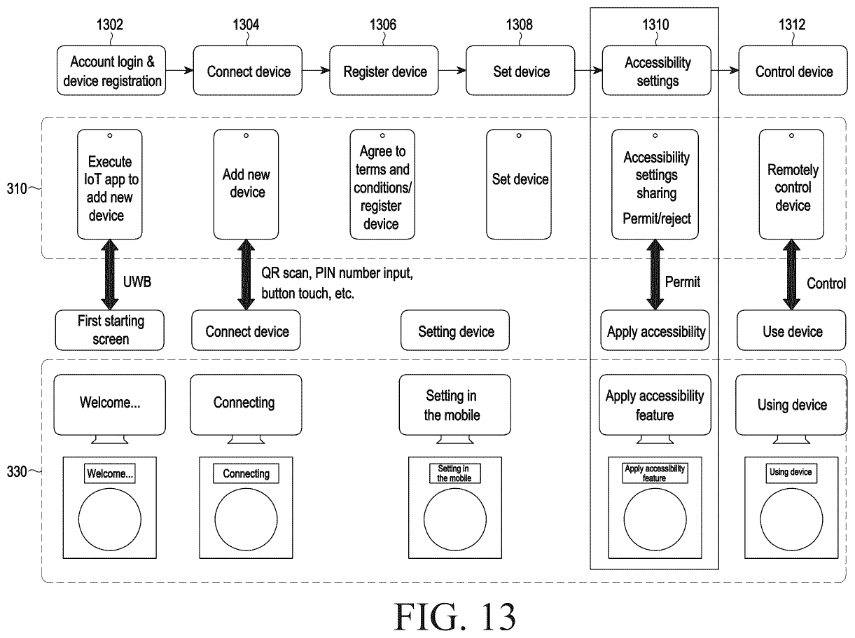

FIG. 13 illustrates a procedure of performing accessibility settings sharing during onboarding according to an example embodiment.

Referring to FIG. 13, in operation 1302, the first electronic device 310 may execute an IoT client application and may perform new device addition through the IoT client application. In an embodiment, the first electronic device 310 may log in to the server 350 through the IoT client application. In an embodiment, the first electronic device 310 may identify the existence of the second electronic device 330 through a designated short-range communication scheme (for example, Wi-Fi, Bluetooth, and/or UWB) in order to execute the new device addition. In an embodiment, the second electronic device 330 may display the first starting screen for onboarding.

In operation 1304, the first electronic device 310 may be connected to the second electronic device 330 for onboarding. In an embodiment, the first electronic device 310 may start onboarding of the second electronic device 330, based on at least one of an operation of scanning the quick response (QR) code attached to the housing of the second electronic device 330 or to a product box by using the camera (for example, the camera module 280 in FIG. 2) of the first electronic device 310, an operation of receiving designated personal identification number (PIN) information input thereto, or an operation of physically contacting (for example, tapping) the first electronic device 310 to the second electronic device 330. In an embodiment, the second electronic device 330 may be connected to the first electronic device 310, based on receiving a designated user input (for example, a button push or a touch on the screen).

In operation 1306, the first electronic device 310 may conduct device registration (for example, a user input regarding agreement to terms and conditions), based on being connected to the second electronic device 330. In operation 1308, the first electronic device 310 may perform device settings (for example, setting functions of the second electronic device 330), based on being connected to the second electronic device 330. In an embodiment, the second electronic device 330 may log in to the server 350 with the same user account as the user account of the first electronic device 310.

In operation 1310, the first electronic device 310 may display an accessibility settings sharing user interface, based on accessibility settings sharing information received from the server 350 or the second electronic device 330. The first electronic device 310 may transmit response information to the server 350 or the second electronic device 330 to indicate that a user input that permits use of a designated accessibility feature is received through the accessibility settings sharing user interface. The second electronic device 330 may turn on at least one accessibility feature indicated by the accessibility settings sharing information, based on the response information.

In operation 1312, the first electronic device 310 may remotely control the second electronic device 330 which has completed onboarding and registration through the IoT client application. The second electronic device 330 may display a screen or output a sound, based on at least one accessibility feature indicated by the accessibility settings sharing information, while the second electronic device 330 is being used.

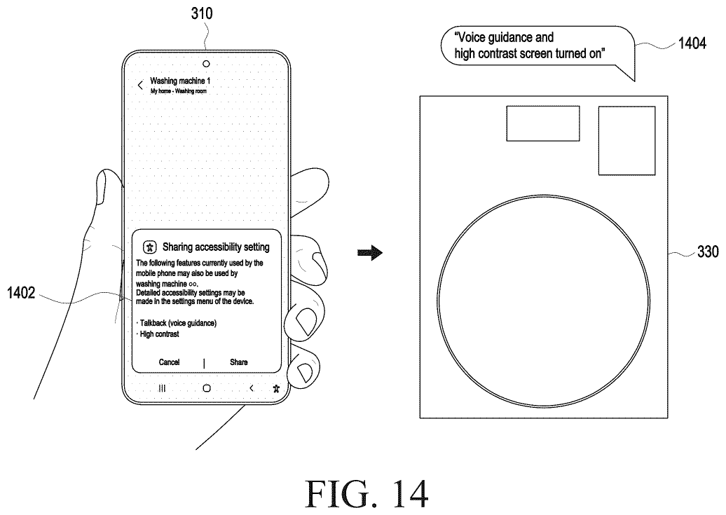

FIG. 14 illustrates an accessibility settings sharing user interface according to an example embodiment.

Referring to FIG. 14, based on receiving accessibility settings sharing information from the server 350 or the second electronic device 330, the first electronic device 310 may display an accessibility settings sharing user interface 1402 which guides at least one accessibility feature (for example, talkback (voice guidance) and high contrast screen) indicated by the accessibility settings sharing information. In case of receiving a user input for selecting “Share” through the accessibility settings sharing user interface 1402, the first electronic device 310 may transmit response information to the server 350 or the second electronic device 330 to inform that at least one accessibility feature is permitted.

In an embodiment, the second electronic device 330 may turn on the at least one accessibility feature (for example, voice guidance and high contrast screen), based on the response information, and may output visual or auditory information 1404 (for example, “Voice guidance and high contrast screen turned on”) to inform that the at least one accessibility feature (for example, voice guidance and high contrast screen) is applied.

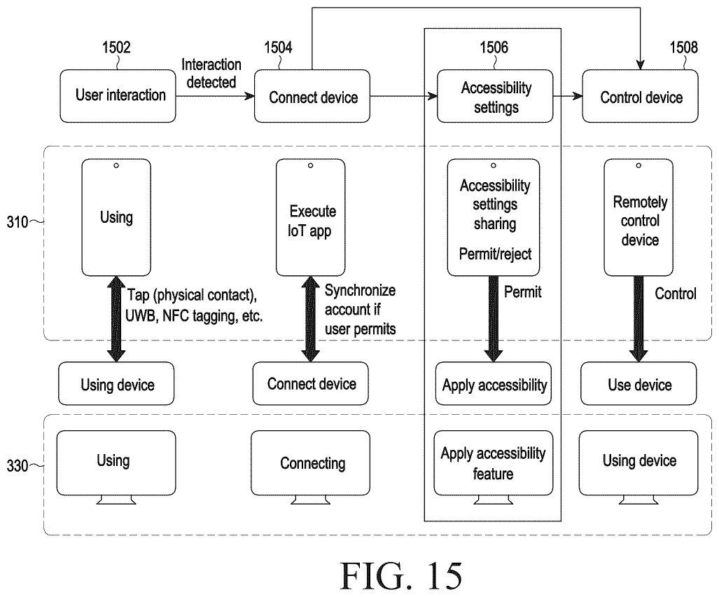

FIG. 15 illustrates a procedure of performing accessibility settings sharing based on a user action according to an example embodiment.

Referring to FIG. 15, in operation 1502, the first electronic device 310 (for example, processor 220) may detect a user interaction for recognizing the second electronic device 330 while performing an operation (for example, while executing an application other than the IoT client application, or in a screen off state). In an embodiment, the user interaction may include at least one of an operation of physically contacting (for example, tapping) the first electronic device 310 to the second electronic device 330, an operation of discovering the second electronic device 330 through a designated short-range communication scheme (for example, Wi-Fi, Bluetooth, or UWB), or an operation of recognizing a near-field communication (NFC) tag related to the second electronic device 330. In an embodiment, the second electronic device 330 may detect a user interaction for recognizing the first electronic device 310 while performing an operation (for example, broadcast screen display or screen off state). In an embodiment, the user interaction may include at least one of an operation of identifying that the first electronic device 310 physically contacts (for example, taps) the second electronic device 330, an operation of discovering the first electronic device 310 through a designated short-range communication scheme (for example, Wi-Fi, Bluetooth, or UWB), or an operation of receiving a designated signal (for example, connection request signal) form the first electronic device 310.

In operation 1504, the first electronic device 310 (for example, processor 220) may execute an IoT client application, based on detecting the user interaction, and may be connected to the second electronic device 330 through the IoT client application. In an embodiment, the first electronic device 310 (for example, processor 220) may log into the server 350 through the IoT client application, may identify that the second electronic device 330 is logged in to the server 350 with the same user account, or may control the second electronic device 330 so as to log in to the server 350 with the same user account. In an embodiment, the first electronic device 310 (for example, processor 220) may control the second electronic device 330 so as to switch the account to the same user account as the first electronic device 310, based on identifying that the second electronic device 330 is not logged in, or is logged in with a different user account.

In operation 1506, the first electronic device 310 (for example, processor 220) may display an accessibility settings sharing user interface, based on accessibility settings sharing information received from the server 350 or the second electronic device 330. In an embodiment, the first electronic device 310 (for example, processor 220) may transmit response information to the server 350 or the second electronic device 330 to indicate that a user input that permits use of a designated accessibility feature is received through the accessibility settings sharing user interface. The second electronic device 330 may turn on at least one accessibility feature indicted by the accessibility settings sharing information, based on the response information.

In operation 1508, the first electronic device 310 (for example, processor 220) may remotely control the second electronic device 330 through the IoT client application. The second electronic device 330 may display a screen or output a sound, based on at least one accessibility feature indicted by the accessibility settings sharing information, while the second electronic device 330 is being used.

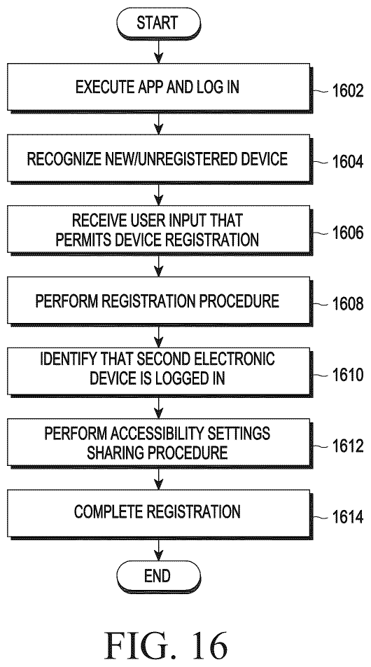

FIG. 16 illustrates a procedure of setting accessibility settings sharing during device registration according to an example embodiment. According to embodiments, at least one of the operations described below may be omitted, modified, or executed in a different order. In an embodiment, at least one of the operations described below may be executed by the processor (for example, the processor 220 in FIG. 2) of the first electronic device 310 (for example, the electronic device 201 in FIG. 2). In an embodiment, the memory (for example, the memory 230 in FIG. 2) of the first electronic device 310 may store instructions which cause the first electronic device 310 to operate according to at least one of the operations described below.

Referring to FIG. 16, in operation 1602, the first electronic device 310 (for example, the processor 220) may execute an IoT client application and may log in (for example, sign in) to the server 350 with a user account through the IoT client application. In operation 1604, the first electronic device 310 (for example, the processor 220) may identify that the second electronic device 330 is a new device or an unregistered device through the IoT client application. In an embodiment, the first electronic device 310 (for example, the processor 220) may display a user interface that recommends device registration.

In operation 1606, the first electronic device 310 (for example, the processor 220) may receive a user input that permits device registration regarding the second electronic device 330. In operation 1608, the first electronic device 310 (for example, the processor 220) may perform a registration procedure regarding the second electronic device 330, based on the user input. The registration procedure may include operations of transmitting network information (for example, the AP name and password) to be used by the second electronic device 330 to establish a connection to the second electronic device 330, and causing the second electronic device 330 to connect to the server 350, based on the network information. In an embodiment, the registration procedure may include operations of transmitting user account information to be used by the second electronic device 330 to the second electronic device 330 such that the second electronic device 330 logs in to the server 350, based on the user account information.

In operation 1610, the first electronic device 310 (for example, the processor 220) may receive information (for example, user account information) indicating that the second electronic device 330 is logged in from the server 350 or the second electronic device 330. In operation 1612, the first electronic device 310 (for example, the processor 220) may perform an accessibility settings sharing procedure regarding the second electronic device 330. In an embodiment, the accessibility settings sharing procedure may include operations 1106, 1108, 1110, and 1112 in FIG. 11. By means of the accessibility settings sharing procedure, the second electronic device 330 may turn on accessibility feature identical or similar to that currently used by the first electronic device 310.

In operation 1614, the first electronic device 310 (for example, the processor 220) may display a notification indicating that the registration procedure, including accessibility settings sharing, has been completed.

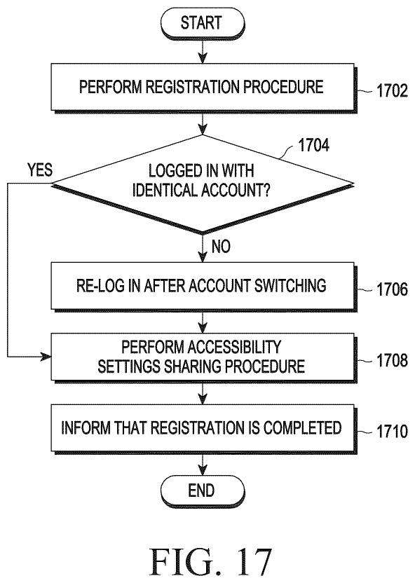

FIG. 17 is a flowchart illustrating a procedure of performing accessibility settings sharing by an IoT device during device registration according to an example embodiment. According to embodiments, at least one of the operations described below may be omitted, modified, or executed in a different order. In an embodiment, at least one of the operations described below may be executed by the processor (for example, the processor 412 in FIG. 4A) of the IoT device (for example, the second electronic device 330). In an embodiment, the memory (for example, the memory 416 in FIG. 4A) of the second electronic device 330 may store instructions which cause the second electronic device 330 to operate according to at least one of the operations described below.

Referring to FIG. 17, in operation 1702, the second electronic device 330 (for example, the processor 412) may start a registration procedure through the connection to the first electronic device 310. In an embodiment, the second electronic device 330 (for example, the processor 412) may log in to the server 350 with a designated user account (for example, a prestored user account or a user account input by the user) through the registration procedure. In an embodiment, the second electronic device 330 (for example, the processor 412) may receive user account information of the first electronic device 310 from the server 350 or the first electronic device 310 during the registration procedure.

In operation 1704, the second electronic device 330 (for example, the processor 412) may determine whether the second electronic device 330 is logged in with the same user account as the user account of the first electronic device 310. In case that the second electronic device 330 is logged in with the same user account, the second electronic device 330 (for example, the processor 412) may proceed to operation 1708. In case that the second electronic device 330 is not logged in with the same user account, the second electronic device 330 (for example, the processor 412) may proceed to operation 1706.

In operation 1706, the second electronic device 330 (for example, the processor 412) may perform account switching in order to re-log in to the server 350 with the same user account as the user account of the first electronic device 310, based on user account information of the first electronic device 310.

In operation 1708, the second electronic device 330 (for example, the processor 412) may perform an accessibility settings sharing procedure regarding the second electronic device 330. In an embodiment, the accessibility settings sharing procedure may include operations 804, 806, 808, 810, and 812 in FIG. 8. By means of the accessibility settings sharing procedure, the second electronic device 330 (for example, the processor 412) may turn on an accessibility feature identical or similar to that currently used by the first electronic device 310.

In operation 1710, the second electronic device 330 (for example, the processor 412) may output visual or auditory information indicating that accessibility settings sharing has been completed.

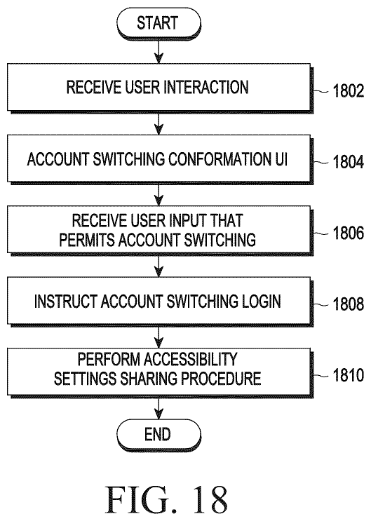

FIG. 18 illustrates a procedure of setting accessibility settings sharing through account switching according to an example embodiment. According to embodiments, at least one of the operations described below may be omitted, modified, or executed in a different order. In an embodiment, at least one of the operations described below may be executed by the processor (for example, the processor 220 in FIG. 2) of the first electronic device 310 (for example, the electronic device 201 in FIG. 2). In an embodiment, the memory (for example, the memory 230 in FIG. 2) of the first electronic device 310 may store instructions which cause the first electronic device 310 to operate according to at least one of the operations described below.

Referring to FIG. 18, in operation 1802, the first electronic device 310 (for example, the processor 220) may detect a user interaction for detecting the second electronic device 330. In an embodiment, the user interaction may include at least one of an operation of physically contacting (for example, tapping) the first electronic device 310 to the second electronic device 330, an operation of discovering the second electronic device 330 through a designated short-range communication scheme (for example, Wi-Fi, Bluetooth, or UWB), or an operation of recognizing an NFC tag related to the second electronic device 330. In an embodiment, the first electronic device 310 (for example, the processor 220) may identify that the second electronic device 330 is logged in with a user account different from the user account of the first electronic device 310, based on user account information of the second electronic device 330 received from the server 350 or the second electronic device 330.

In operation 1804, the first electronic device 310 (for example, the processor 220) may display an account switching confirmation user interface which guides account switching to be performed. In operation 1806, the first electronic device 310 (for example, the processor 220) may receive a user input that permits account switching to be performed by the second electronic device 330 through the account switching confirmation user interface. In operation 1808, the first electronic device 310 (for example, the processor 220) may transmit information (for example, user account information) instructing to log in with the same user account as the user account of the first electronic device 310 to the second electronic device 330, based on the user input.

In operation 1810, the first electronic device 310 (for example, the processor 220) may perform an accessibility settings sharing procedure regarding the second electronic device 330, based on identifying that the second electronic device 330 is logged in with the same user account as the user account of the first electronic device 310 by means of the account switching.

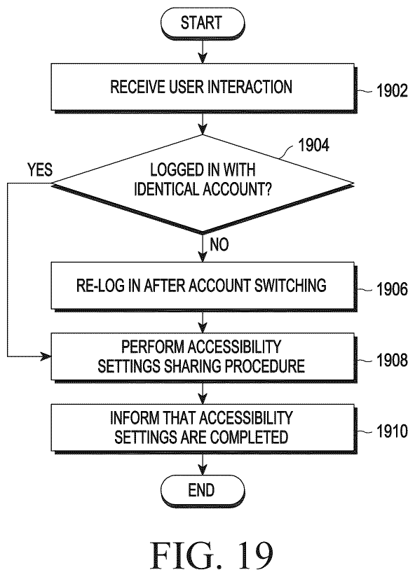

FIG. 19 is a flowchart illustrating a procedure of performing accessibility settings sharing by an IoT device during a user interaction according to an example embodiment. According to embodiments, at least one of the operations described below may be omitted, modified, or executed in a different order. In an embodiment, at least one of the operations described below may be executed by the processor (for example, the processor 412 in FIG. 4A) of the IoT device (for example, the second electronic device 330). In an embodiment, the memory (for example, the memory 416 in FIG. 4A) of the second electronic device 330 may store instructions which cause the second electronic device 330 to operate according to at least one of the operations described below.

Referring to FIG. 19, in operation 1902, the second electronic device 330 (for example, the processor 412) may detect a user interaction for recognizing the first electronic device 310. In an embodiment, the user interaction may include an operation of identifying the first electronic device 310 physically contacting (for example, tapping) the second electronic device 330, or an operation of discovering the first electronic device 310 through a designated short-range communication scheme (for example, Wi-Fi, Bluetooth, or UWB).

In operation 1904, the second electronic device 330 (for example, the processor 412) may determine whether the second electronic device 330 is logged in with the same user account as the user account of the first electronic device 310, based on detecting the user interaction. In case that the second electronic device 330 is logged in with the same user account, the second electronic device 330 (for example, the processor 412) may proceed to operation 1908. In case that the second electronic device 330 is not logged in with the same user account, the second electronic device 330 (for example, the processor 412) may proceed to operation 1906.

In operation 1906, the second electronic device 330 (for example, the processor 412) may perform account switching in order to re-log in to the server 350 with the same user account as the user account of the first electronic device 310, based on user account information of the first electronic device 310.

In operation 1908, the second electronic device 330 (for example, the processor 412) may perform an accessibility settings sharing procedure regarding the second electronic device 330. In an embodiment, the accessibility settings sharing procedure may include operations 804, 806, 808, 810, and 812 in FIG. 8. By means of the accessibility settings sharing procedure, the second electronic device 330 (for example, the processor 412) may turn on an accessibility feature identical or similar to that currently used by the first electronic device 310.

In operation 1910, the second electronic device 330 (for example, the processor 412) may output visual or auditory information indicating that accessibility settings have been completed (or accessibility features have been applied).

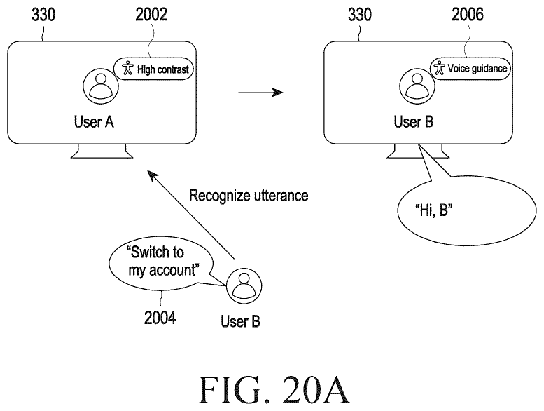

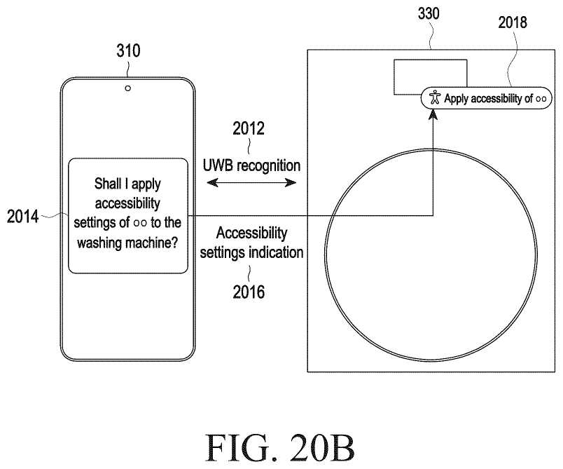

FIG. 20A illustrates accessibility settings sharing based on a voice command according to an example embodiment.

Referring to FIG. 20A, the second electronic device 330 may be logged in with the user account (for example, account A) of user A. In an embodiment, the second electronic device 330 may turn on accessibility feature A (for example, high contrast screen feature 2002) while being logged in with account A.

In an embodiment, the second electronic device 330 may receive a command requesting account switching to user B. In an embodiment, the command may include a voice command 2004 of user B. In an embodiment, the second electronic device 330 may identify that the voice command 2004 includes the voice of user B through voice recognition regarding the voice command 2004, and may perform account switching to the prestored user account (for example, account B) of user B (for example, re-log in with account B).

In an embodiment, the second electronic device 330 may compare the voice characteristics of the voice command 2004 with preregistered user voice characteristics, based on receiving the voice command 2004, and may identify that the voice command has been uttered from user B according to the result of comparison. In an embodiment, the preregistered user voice characteristics may be prestored in the second electronic device 330 through an input means (for example, microphone) or may be stored in the second electronic device 330 through an external electronic device (for example, the server 350, the second electronic device 330, or the hub) connected to the second electronic device 330.

In an embodiment, the second electronic device 330 may automatically perform account switching to the account of user B, based on identifying the user (for example, user B) of the voice command, or may automatically perform account switching to the account of the user (for example, user B or user C) identified according to the meaning of the voice command (for example, “Switch to my account” or “Log in as user C”).

In an embodiment, the second electronic device 330 may identify accessibility feature B (for example, voice guidance feature 2006) corresponding to account B, based on account switching to account B. In an embodiment, the second electronic device 330 may receive information (for example, accessibility feature list 602) indicating the accessibility feature corresponding to account B from the server 350 or from first electronic device 310 which is logged in with account B. In an embodiment, the second electronic device 330 may turn on accessibility feature B (for example, voice guidance feature 2006) while being logged in with account B.

FIG. 20B illustrates accessibility settings sharing based on a short-range communication scheme according to an example embodiment.

Referring to FIG. 20B, the first electronic device 310 may identify the existence of the second electronic device 330, based on a short-range communication scheme 2012 (for example, Wi-Fi, Bluetooth, and/or UWB). In an embodiment, the first electronic device 310 may display an accessibility settings sharing user interface 2014 indicating accessibility settings (for example, at least one accessibility feature) of the first electronic device 310, based on identifying the existence of the second electronic device 330. In an embodiment, the first electronic device 310 may receive a user input that permits accessibility settings sharing through the accessibility settings sharing user interface 2014. In an embodiment, the first electronic device 310 may transmit an accessibility settings indication 2016 to the second electronic device 330 so as to indicate that the at least one accessibility feature is to be applied, based on receiving the user input. In an embodiment, the second electronic device 330 may turn on the at least one accessibility feature, based on the accessibility settings indication 2016, and may output visual or auditory information 2018 informing that accessibility settings sharing has been performed (for example, “Accessibility settings of ○○ have been applied” or “Accessibility feature ∘∘ has been applied”).

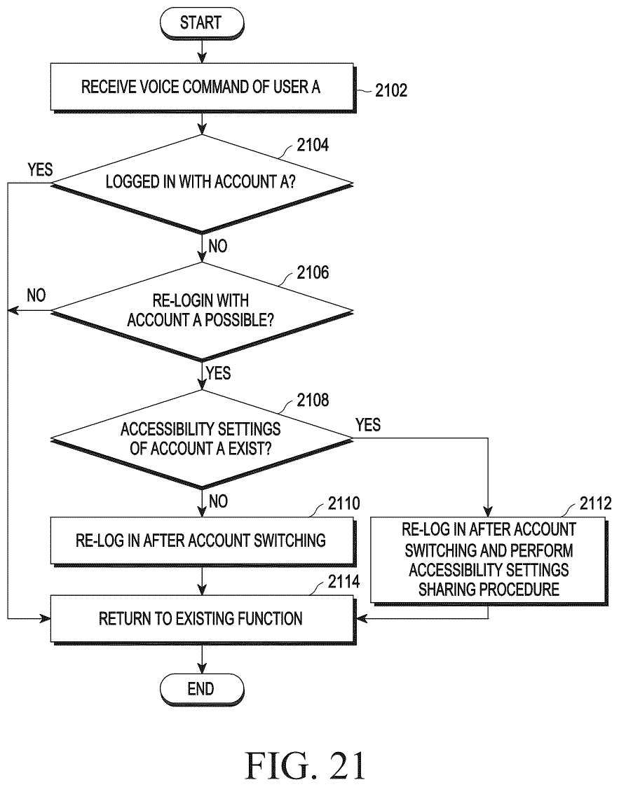

FIG. 21 is a flowchart illustrating a procedure of performing accessibility settings sharing by a voice command according to an example embodiment. According to embodiments, at least one of the operations described below may be omitted, modified, or executed in a different order. In an embodiment, at least one of the operations described below may be executed by the processor (for example, the processor 412 in FIG. 4A) of an IoT device (for example, the second electronic device 330). In an embodiment, the memory (for example, the memory 416 in FIG. 4A) of the second electronic device 330 may store instructions which cause the second electronic device 330 to operate according to at least one of the operations described below.

Referring to FIG. 21, in operation 2102, the second electronic device 330 (for example, the processor 412) may receive a voice command, and may identify that the voice command includes the voice of user A through voice recognition. In an embodiment, the voice command may include a command that indicates account switching (for example, “Switch to my account”), or a command that instructs the second electronic device 330 to perform a native function (for example, “Turn on TV”).

In operation 2104, the second electronic device 330 (for example, the processor 412) may determine whether the second electronic device 330 is logged in with the user account (for example, account A) of user A or not. In case that the second electronic device 330 is logged in with account A, the second electronic device 330 (for example, the processor 412) may proceed to operation 2114. In operation 2114, the second electronic device 330 (for example, the processor 412) may perform a function according to the voice command, or may return to the existing function. In case that the second electronic device 330 is not logged in with account A, the second electronic device 330 (for example, the processor 412) may proceed to operation 2106.

In operation 2106, the second electronic device 330 (for example, the processor 412) may determine whether it is possible to re-log in with account A or not. In an embodiment, in case that login information (for example, account name and password) of account A is not stored, the second electronic device 330 (for example, the processor 412) may determine that it is not possible to re-log in with account A, and may proceed to operation 2114. In an embodiment, in case that login information (for example, account name and password) of account A is stored, the second electronic device 330 (for example, the processor 412) may determine that it is possible to re-log in with account A, and may proceed to operation 2108.

In operation 2108, the second electronic device 330 (for example, the processor 412) may determine whether there are accessibility settings (for example, at least one accessibility feature) corresponding to account A or not. In case that accessibility settings corresponding to account A do not exist, the second electronic device 330 (for example, the processor 412) may proceed to operation 2110. In case that accessibility settings corresponding to account A exist, the second electronic device 330 (for example, the processor 412) may proceed to operation 2112.

In operation 2110, the second electronic device 330 (for example, the processor 412) may re-log in with account A through account switching. After operation 2110, the second electronic device 330 (for example, the processor 412) may proceed to operation 2114 and may return to the existing function.

In operation 2112, the second electronic device 330 (for example, the processor 412) may re-log in with account A through account switching, and may then perform an accessibility settings sharing procedure corresponding to account A. In an embodiment, the accessibility settings sharing procedure may include operations 804, 806, 808, 810, and 812 in FIG. 8. After operation 2112, the second electronic device 330 (for example, the processor 412) may proceed to operation 2114 and may return to the existing function.

According to an example embodiment, accessibility settings of the first electronic device 310 may be applied to the second electronic device 330, based on analyzing accessibility information of the first electronic device 310 and the second electronic device 330 when conducting settings synchronization. According to an example embodiment, accessibility settings may be switched according to the user account through account switching, and accessibility settings currently used by the first electronic device 310 may be synchronized with the second electronic device 330, based on the user account.

According to an example embodiment, accessibility features that can be used in common may be shred between multiple devices (for example, the first electronic device 310 and the second electronic device 330), thereby improving the user's accessibility experiences.

A second electronic device 330 according to an example embodiment may include communication circuitry 414 configured to support a communication connection, memory 416 configured to store instructions, and at least one processor 412 functionally connected to the communication circuitry and the memory. The instructions, when executed by the at least one processor individually or collectively, may cause the second electronic device to: log in to a server with a user account through the communication circuitry, based on an application; in case that a first electronic device is logged in to the server with the user account, receive an accessibility feature list indicating at least one accessibility feature from the server or the first electronic device through the communication circuitry, based on the application; identify at least one accessibility feature usable by the second electronic device from the at least one accessibility feature corresponding to the accessibility feature list; identify, from the identified at least one accessibility feature, a first accessibility feature that is not being used by the second electronic device; and apply accessibility settings corresponding to the identified first accessibility feature to the second electronic device.

A first electronic device 310 according to an example embodiment may include communication circuitry 292 configured to support a communication connection, memory 230 configured to store instructions, and at least one processor 220 functionally connected to the communication circuitry and the memory. The instructions, when executed by the at least one processor individually or collectively, may cause the first electronic device to: in a state in which the first electronic device is logged in to a server with a user account, based on an application, receive a user interaction regarding the first electronic device; control the second electronic device through the communication circuitry such that the second electronic device is logged in to the server with the user account in response to the user interaction; detect an event in which the second electronic device is logged in to the server with the user account through the application; based on detecting the event, identify at least one accessibility feature that is set for the first electronic device; and transmit an accessibility feature list indicating the at least one accessibility feature to the server or the second electronic device through the communication circuitry such that the second electronic device applies accessibility settings corresponding to the accessibility feature list.

In an embodiment, the instructions, when executed by the at least one processor individually or collectively, may cause the first electronic device to: based on the user interaction, transmit a signal requesting at least one accessibility feature to be applied to the second electronic device to the server.

In an embodiment, the accessibility feature list may include the list of at least one accessibility feature that can be applied to the second electronic device, among one or more accessibility features that can be used by the first electronic device.

In an embodiment, the instructions, when executed by the at least one processor individually or collectively, may cause the first electronic device to share the at least one accessibility feature with the second electronic device, based on identifying that onboarding of the second electronic device is performed, receiving a user input requesting sharing of accessibility settings regarding the second electronic device, or identifying that the first electronic device approaches the second electronic device.

A server according to an example embodiment may include communication circuitry configured to support a communication connection, at least one processor functionally connected to the communication circuitry, and memory configured to store instructions. The instructions, when executed by the at least one processor individually or collectively, may cause the server to: identify that a first electronic device is logged in to the server with a user account; identify that a second electronic device is logged in to the server with the user account; based on identifying that the second electronic device is logged in in a state in which the first electronic device is logged in, identify at least one accessibility feature that can be used by the second electronic device among one or more accessibility features that are set for the first electronic device; and transmit an accessibility feature list indicating the at least one accessibility feature to the second electronic device through the communication circuitry.

A second electronic device 330 according to an example embodiment may include communication circuitry 414, at least one processor 412, and memory 416 storing instructions. The instructions, when executed by the at least one processor individually or collectively, may cause the second electronic device to: log in to a server 350 with a user account through the communication circuitry. The instructions, when executed by the at least one processor individually or collectively, may cause the second electronic device to: while the second electronic device is logged in with the user account, receive, through the communication circuitry, an accessibility feature list indicating at least one accessibility feature in use on a first electronic device 310, wherein the first electronic device is logged in to the server with the user account. The instructions, when executed by the at least one processor individually or collectively, may cause the second electronic device to: identify at least one accessibility feature usable by the second electronic device from the accessibility feature list. The instructions, when executed by the at least one processor individually or collectively, may cause the second electronic device to: identify, from the identified at least one accessibility feature usable by the second electronic device, a first accessibility feature that is not being used by the second electronic device. The instructions, when executed by the at least one processor individually or collectively, may cause the second electronic device to: apply the first accessibility feature to the second electronic device.

In an embodiment, the instructions, when executed by the at least one processor individually or collectively, may cause the second electronic device to: based on the second electronic device being firstly registered to the server after the second electronic device is onboarded, transmit, to the server or the first electronic device, a signal requesting the accessibility feature list.

In an embodiment, the instructions, when executed by the at least one processor individually or collectively, may cause the second electronic device to: based on detecting a designated user action while the second electronic device is logged in with the user account, transmit, to the server or the first electronic device, a signal requesting the accessibility feature list.

In an embodiment, the instructions, when executed by the at least one processor individually or collectively, may cause the second electronic device to: based on identifying that the second electronic device is logged in with a first user account that is different from the user account, re-log in with the user account via account switching.

In an embodiment, the instructions, when executed by the at least one processor individually or collectively, may cause the second electronic device to: transmit, to the first electronic device, accessibility settings sharing information for the first accessibility feature; and based on receiving information accepting to apply the first accessibility feature to the second electronic device from the first electronic device after transmitting the accessibility settings sharing information, apply the first accessibility feature to the second electronic device.

In an embodiment, the first accessibility feature may include at least one of voice guidance, a high contrast screen, color inversion, a black and white screen, relumino mode, audio descriptions, or closed captions.

A server 350 according to an example embodiment may include communication circuitry 424, at least one processor 422, and memory 426 storing instructions. The instructions, when executed by the at least one processor individually or collectively, may cause the server to: identify that a first electronic device 310 is logged in with a user account. The instructions, when executed by the at least one processor individually or collectively, may cause the server to: identify that a second electronic device 330 is logged in with the user account. The instructions, when executed by the at least one processor individually or collectively, may cause the server to: while the first electronic device and the second electronic device are logged in with the user account, receive, through the communication circuitry, a first accessibility feature list indicating at least one accessibility feature in use on the first electronic device. The instructions, when executed by the at least one processor individually or collectively, may cause the server to: while the first electronic device and the second electronic device are logged in with the user account, receive, through the communication circuitry, a second accessibility feature list indicating at least one accessibility feature in use on the second electronic device. The instructions, when executed by the at least one processor individually or collectively, may cause the server to: identify at least one accessibility feature usable by the second electronic device from the first accessibility feature list. The instructions, when executed by the at least one processor individually or collectively, may cause the server to: identify, from the identified at least one accessibility feature, a first accessibility feature that is not being used by the second electronic device, based on the second accessibility feature list. The instructions, when executed by the at least one processor individually or collectively, may cause the server to: transmit an accessibility settings indication to the second electronic device through the communication circuitry so as to indicate that the identified first accessibility feature is to be applied.

In an embodiment, the instructions, when executed by the at least one processor individually or collectively, may cause the server to: based on the second electronic device being firstly registered to the server after the second electronic device is onboarded, transmit, to the second electronic device, a signal requesting the second accessibility feature list.

In an embodiment, the instructions, when executed by the at least one processor individually or collectively, may cause the server to: based on receiving a designated request signal from the first electronic device or the second electronic device, transmit a signal requesting the first accessibility feature list to the first electronic device, and/or transmit a signal requesting the second accessibility feature list to the second electronic device.

In an embodiment, the instructions, when executed by the at least one processor individually or collectively, may cause the server to: transmit, to the first electronic device, accessibility settings sharing information for the first accessibility feature; and based on receiving, from the first electronic device, information accepting to apply the first accessibility feature to the second electronic device after transmitting the accessibility settings sharing information, transmit the accessibility settings indication to the second electronic device.

A first electronic device 310 according to an example embodiment may include communication circuitry 292, at least one processor 220, and memory 230 storing instructions. The instructions, which, when executed by the at least one processor individually or collectively, may cause the first electronic device to: while the first electronic device is logged in to a server 350 with a user account, based on execution of an application, identify that a second electronic device 330 is logged in with the user account. The instructions, which, when executed by the at least one processor individually or collectively, may cause the first electronic device to: based on identifying that the second electronic device is logged in with the user account, transmit an accessibility feature list indicating at least one accessibility feature in use on the first electronic device to the server or the second electronic device through the communication circuitry. The instructions, which, when executed by the at least one processor individually or collectively, may cause the first electronic device to: after transmitting the accessibility feature list, receive accessibility settings sharing information indicating a first accessibility feature among the at least one accessibility feature from the server or the second electronic device through the communication circuitry. The instructions, which, when executed by the at least one processor individually or collectively, may cause the first electronic device to: after displaying a user interface including the accessibility settings sharing information, receive a user input accepting to apply the first accessibility feature to the second electronic device through the user interface. The instructions, which, when executed by the at least one processor individually or collectively, may cause the first electronic device to: based on receiving the user input, transmit information accepting to apply the first accessibility feature to the second electronic device to the second electronic device directly or through the server.

A method by a second electronic device 330 according to an example embodiment may include an operation 802 of logging in to a server 350 with a user account; an operation 804 of, while the second electronic device is logged in with the user account, acquiring an accessibility feature list indicating at least one accessibility feature in use on a first electronic device 310, wherein the first electronic device is logged in to the server with the user account; an operation 806 of identifying at least one accessibility feature usable by the second electronic device from the accessibility feature list; an operation 808 of identifying, from the at least one accessibility feature usable by the second electronic device, a first accessibility feature that is not being used by the second electronic device; and an operation 812 of applying the first accessibility feature to the second electronic device.

In an embodiment, the method may further include an operation of, based on the second electronic device being firstly registered to the server after the second electronic device is onboarded, transmitting, to the server or the first electronic device, a signal requesting the accessibility feature list.

In an embodiment, the method may further include an operation of, based on detecting a designated user action while the second electronic device is logged in with the user account, transmitting, to the server or the first electronic device, a signal requesting the accessibility feature list.

In an embodiment, the operation of logging in may include an operation of re-logging in with the user account through account switching, based on identifying that the second electronic device is logged in with a first user account different from the user account.

In an embodiment, the operation of applying may include an operation of transmitting accessibility settings sharing information regarding the first accessibility feature to the first electronic device, and an operation of applying the first accessibility feature to the second electronic device, based on receiving information which permits application of the first accessibility feature to the second electronic device from the first electronic device, after transmitting the accessibility settings sharing information.

A method by a server 350 according to an example embodiment may include an operation 902 of identifying that a first electronic device 310 is logged in with a user account; an operation 904 of identifying that a second electronic device 330 is logged in with the user account; an operation 906 of, while the first electronic device and the second electronic device are logged in with the user account, receiving a first accessibility feature list indicating at least one accessibility feature in use on the first electronic device; an operation 906 of, while the first electronic device and the second electronic device are logged in with the user account, receiving a second accessibility feature list indicating at least one accessibility feature in use on the second electronic device; an operation 908 of identifying at least one accessibility feature usable by the second electronic device from the first accessibility feature list; an operation 910 of identifying, from the identified at least one accessibility feature, a first accessibility feature that is not being used by the second electronic device, based on the second accessibility feature list; and an operation 914 of transmitting an accessibility settings indication to the second electronic device so as to indicate that the identified first accessibility feature is to be applied.

In an embodiment, the method may further include an operation of, based on the second electronic device being firstly registered to the server after the second electronic device is onboarded, transmitting, to the second electronic device, a signal requesting the second accessibility feature list.

In an embodiment, the method may further include an operation of, based on receiving a designated request signal from the first electronic device or the second electronic device, transmitting a signal requesting the first accessibility feature list to the first electronic device, and/or transmitting a signal requesting the second accessibility feature list to the second electronic device. “Based on” as used herein covers based at least on.

In an embodiment, the operation of transmitting an accessibility settings indication may include: an operation of transmitting, to the first electronic device, accessibility settings sharing information for the first accessibility feature; and an operation of, based on receiving, from the first electronic device, information accepting to apply the first accessibility feature to the second electronic device after transmitting the accessibility settings sharing information, transmit the accessibility settings indication to the second electronic device.

Each embodiment herein may be used in combination with any other embodiment(s) described herein.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element. Thus, for example, “connected” as used herein covers direct and indirect connections.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 240) including one or more instructions that are stored in a storage medium (e.g., internal memory 236 or external memory 238) that is readable by a machine (e.g., the electronic device 201). For example, a processor (e.g., the processor 220) of the machine (e.g., the electronic device 201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. A second electronic device, comprising:
communication circuitry;
at least one processor comprising processing circuitry; and
memory storing instructions, which, when executed by the at least one processor individually and/or collectively, cause the second electronic device to:
log in to a server with a user account through at least the communication circuitry,
while the second electronic device is logged in with the user account, receive an accessibility feature list indicating at least one accessibility feature in use on a first electronic device logged in to the server with the user account,
identify at least one accessibility feature usable by the second electronic device from the accessibility feature list,
identify, from the identified at least one accessibility feature usable by the second electronic device, a first accessibility feature that is not being used by the second electronic device, and
apply the first accessibility feature to the second electronic device.

2. The second electronic device of claim 1, wherein the instructions, when executed by the at least one processor individually and/or collectively, cause the second electronic device to, based on the second electronic device being firstly registered to the server after the second electronic device is onboarded, transmit, to the server and/or the first electronic device, a signal requesting the accessibility feature list.

3. The second electronic device of claim 1, wherein the instructions, when executed by the at least one processor individually and/or collectively, cause the second electronic device to, based on detecting a designated user action while the second electronic device is logged in with the user account, transmit, to the server and/or the first electronic device, a signal requesting the accessibility feature list.

4. The second electronic device of claim 1, wherein the instructions, when executed by the at least one processor individually and/or collectively, cause the second electronic device to, based on identifying that the second electronic device is logged in with a first user account that is different from the user account, re-log in with the user account via account switching.

5. The second electronic device of claim 1, wherein the instructions, when executed by the at least one processor individually and/or collectively, cause the second electronic device to:
transmit, to the first electronic device, accessibility settings sharing information for the first accessibility feature, and
based on receiving information accepting to apply the first accessibility feature to the second electronic device after transmitting the accessibility settings sharing information, apply the first accessibility feature to the second electronic device.

6. The second electronic device of claim 1, wherein the first accessibility feature comprises at least one of:
voice guidance, a high contrast screen, color inversion, a black and white screen, Relumino mode, audio descriptions, or closed captions.

7. A server comprising:
communication circuitry;
at least one processor comprising processing circuitry; and
memory storing instructions, which, when executed by the at least one processor individually and/or collectively, cause the server to:
identify that a first electronic device is logged in with a user account,
identify that a second electronic device is logged in with the user account,
while the first electronic device and the second electronic device are logged in with the user account, receive, through at least the communication circuitry, a first accessibility feature list indicating at least one accessibility feature in use on the first electronic device,
while the first electronic device and the second electronic device are logged in with the user account, receive a second accessibility feature list indicating at least one accessibility feature in use on the second electronic device,
identify at least one accessibility feature usable by the second electronic device from the first accessibility feature list,
identify, from the identified at least one accessibility feature, a first accessibility feature that is not being used by the second electronic device, based on the second accessibility feature list, and
transmit an accessibility settings indication to the second electronic device so as to indicate that the identified first accessibility feature is to be applied.

8. The server of claim 7, wherein the instructions, when executed by the at least one processor individually and/or collectively, cause the server to:
based on the second electronic device being firstly registered to the server after the second electronic device is onboarded, transmit, to the second electronic device, a signal requesting the second accessibility feature list.

9. The server of claim 7, wherein the instructions, when executed by the at least one processor individually and/or collectively, cause the server to:
based on receiving a designated request signal from the first electronic device and/or the second electronic device, transmit a signal requesting the first accessibility feature list to the first electronic device, and/or transmit a signal requesting the second accessibility feature list to the second electronic device.

10. The server of claim 7, wherein the instructions, when executed by the at least one processor individually and/or collectively, cause the server to:
transmit, to the first electronic device, accessibility settings sharing information for the first accessibility feature, and
based on receiving, from the first electronic device, information accepting to apply the first accessibility feature to the second electronic device after transmitting the accessibility settings sharing information, transmit the accessibility settings indication to the second electronic device.

11. A first electronic device comprising:
communication circuitry;
at least one processor comprising processing circuitry; and
memory storing instructions, which, when executed by the at least one processor individually or collectively, cause the first electronic device to:
while the first electronic device is logged in to a server with a user account, based on execution of an application, identify that a second electronic device is logged in with the user account,
based on identifying that the second electronic device is logged in with the user account, transmit an accessibility feature list indicating at least one accessibility feature in use on the first electronic device to the server and/or the second electronic device through at least the communication circuitry,
after transmitting the accessibility feature list, receive accessibility settings sharing information indicating a first accessibility feature among the at least one accessibility feature from the server and/or the second electronic device,
after displaying a user interface comprising the accessibility settings sharing information, receive a user input accepting to apply the first accessibility feature to the second electronic device through the user interface, and
based on receiving the user input, transmit information accepting to apply the first accessibility feature to the second electronic device to the second electronic device directly or through the server.

12. A method by a second electronic device, the method comprising:
logging in to a server with a user account;
while the second electronic device is logged in with the user account, acquiring an accessibility feature list indicating at least one accessibility feature in use on a first electronic device logged in to the server with the user account;
identifying at least one accessibility feature usable by the second electronic device from the accessibility feature list;
identifying, from the at least one accessibility feature usable by the second electronic device, a first accessibility feature that is not being used by the second electronic device; and
applying the first accessibility feature to the second electronic device.

13. The method of claim 12, further comprising, based on the second electronic device being firstly registered to the server after the second electronic device is onboarded, transmitting, to the server and/or the first electronic device, a signal requesting the accessibility feature list.

14. The method of claim 12, further comprising, based on detecting a designated user action while the second electronic device is logged in with the user account, transmitting, to the server and/or the first electronic device, a signal requesting the accessibility feature list.

15. The method of claim 12, wherein the logging comprises:
based on identifying that the second electronic device is logged in with a first user account that is different from the user account, re-logging in with the user account via account switching.

16. The method of claim 12, wherein the applying comprises:
transmitting, to the first electronic device, accessibility settings sharing information for the first accessibility feature, and
based on receiving information accepting to apply the first accessibility feature to the second electronic device after transmitting the accessibility settings sharing information, applying the first accessibility feature to the second electronic device.

17. A method by a server, the method comprising:
identifying that a first electronic device is logged in with a user account;
identifying that a second electronic device is logged in with the user account;
while the first electronic device and the second electronic device are logged in with the user account, receiving a first accessibility feature list indicating at least one accessibility feature in use on the first electronic device;
while the first electronic device and the second electronic device are logged in with the user account, receiving a second accessibility feature list indicating at least one accessibility feature in use on the second electronic device;
identifying at least one accessibility feature usable by the second electronic device from the first accessibility feature list;
identifying, from the identified at least one accessibility feature, a first accessibility feature that is not being used by the second electronic device, based on the second accessibility feature list; and
transmitting an accessibility settings indication to the second electronic device so as to indicate that the identified first accessibility feature is to be applied.

18. The method of claim 17, further comprising:
based on the second electronic device being firstly registered to the server after the second electronic device is onboarded, transmitting, to the second electronic device, a signal requesting the second accessibility feature list.

19. The method of claim 17, further comprising:
based on receiving a designated request signal from the first electronic device and/or the second electronic device, transmitting a signal requesting the first accessibility feature list to the first electronic device, and/or transmitting a signal requesting the second accessibility feature list to the second electronic device.

20. The method of claim 17, wherein the transmitting the accessibility settings indication comprises:
transmitting, to the first electronic device, accessibility settings sharing information for the first accessibility feature, and
based on receiving, from the first electronic device, information accepting to apply the first accessibility feature to the second electronic device after transmitting the accessibility settings sharing information, transmitting the accessibility settings indication to the second electronic device.
